(19) United States
(12) Patent Application Publication
(10) Pub. No.: US 2021/0287382 A1
(43) Pub. Date: Sep. 16, 2021

(54) SYSTEMS AND METHODS FOR MULTI-USER VIRTUAL AND AUGMENTED REALITY

(71) Applicant: MAGIC LEAP, INC., Plantation, FL (US)

(72) Inventors: Daniel LeWinn LEHRICH, Miami, FL (US); Marissa Jean TRAIN, Fort Lauderdale, FL (US); David Charles LUNDMARK, Los Altos, CA (US)

(73) Assignee: MAGIC LEAP, INC., Plantation, FL (US)

(21) Appl. No.: 17/200,760

(22) Filed: Mar. 12, 2021

Related U.S. Application Data
(60) Provisional application No. 62/989,584, filed on Mar. 13, 2020.

(51) Int. Cl. G06T 7/33; G06T 19/00; G06F 3/14; A63F 13/426

(52) U.S. Cl. CPC G06T 7/33; G06T 19/006; G06F 3/1423; A63F 13/573; G06T 2219/024; A63F 2300/8082; A63F 13/426

(57) ABSTRACT

An apparatus for providing a virtual content in an environment which first and second users can interact with each other, comprising: a communication interface configured to communicate with a first display screen worn by the first user and/or a second display screen worn by the second user; and a processing unit configured to: obtain a first position of the first user, determine a first set of anchor point(s) based on the first position of the first user, obtain a second position of the second user, determine a second set of anchor point(s) based on the second position of the second user, determine one or more common anchor points that are in both the first set and the second set, and provide the virtual content for experience by the first user and/or the second user based on at least one of the one or more common anchor points.

### RELATED APPLICATION DATA

This application claims priority to, and the benefit of, U.S. Provisional Patent Application No. 62/989,584, filed on Mar. 13, 2020. The entire disclosure of the above application is expressly incorporated by reference herein.

### FIELD

The present disclosure relates to computing, learning network configurations, and connected mobile computing systems, methods, and configurations, and more specifically to mobile computing systems, methods, and configurations featuring at least one wearable component which may be utilized for virtual and/or augmented reality operation.

### BACKGROUND

Modern computing and display technologies have facilitated the development of “mixed reality” (MR) systems for so called “virtual reality” (VR) or “augmented reality” (AR) experiences, wherein digitally reproduced images or portions thereof are presented to a user in a manner wherein they seem to be, or may be perceived as, real. A VR scenario typically involves presentation of digital or virtual image information without transparency to actual real-world visual input. An AR scenario typically involves presentation of digital or virtual image information as an augmentation to visualization of the real world around the user (i.e., transparency to real-world visual input). Accordingly, AR scenarios involve presentation of digital or virtual image information with transparency to the real-world visual input.

MR systems may generate and display color data, which increases the realism of MR scenarios. Many of these MR systems display color data by sequentially projecting sub-images in different (e.g., primary) colors or “fields” (e.g., Red, Green, and Blue) corresponding to a color image in rapid succession. Projecting color sub-images at sufficiently high rates (e.g., 60 Hz, 120 Hz, etc.) may deliver a smooth color MR scenario in a user's mind.

Various optical systems generate images, including color images, at various depths for displaying MR (VR and AR) scenarios. Some such optical systems are described in U.S. Utility patent application Ser. No. 14/555,585 filed on Nov. 27, 2014 (attorney docket number ML.20011.00), the contents of which are hereby expressly and fully incorporated by reference in their entirety, as though set forth in full.

MR systems may employ wearable display devices (e.g., head-worn displays, helmet-mounted displays, or smart glasses) that are at least loosely coupled to a user's head, and thus move when the user's head moves. If the user's head motions are detected by the display device, the data being displayed can be updated (e.g., “warped”) to take the change in head pose (i.e., the orientation and/or location of user's head) into account.

As an example, if a user wearing a head-worn display device views a virtual representation of a virtual object on the display and walks around an area where the virtual object appears, the virtual object can be rendered for each viewpoint, giving the user the perception that they are walking around an object that occupies real space. If the head-worn display device is used to present multiple virtual objects, measurements of head pose can be used to render the scene to match the user's dynamically changing head pose and provide an increased sense of immersion.

Head-worn display devices that enable AR provide concurrent viewing of both real and virtual objects. With an “optical see-through” display, a user can see through transparent (e.g., semi-transparent or full-transparent) elements in a display system to view directly the light from real objects in an environment. The transparent element, often referred to as a “combiner,” superimposes light from the display over the user's view of the real world, where light from by the display projects an image of virtual content over the see-through view of the real objects in the environment. A camera may be mounted onto the head-worn display device to capture images or videos of the scene being viewed by the user.

Current optical systems, such as those in MR systems, optically render virtual content. Content is “virtual” in that it does not correspond to real physical objects located in respective positions in space. Instead, virtual content only exist in the brains (e.g., the optical centers) of a user of the head-worn display device when stimulated by light beams directed to the eyes of the user.

In some cases, a head-worn image display device may display virtual objects with respect to a real environment, and/or may allow a user to place and/or manipulate virtual objects with respect to the real environment. In such cases, the image display device may be configured to localize the user with respect to the real environment, so that virtual objects may be correctly displaced with respect to the real environment.

It is desirable that mixed reality, or augmented reality, near-eye displays be lightweight, low-cost, have a small form-factor, have a wide virtual image field of view, and be as transparent as possible. In addition, it is desirable to have configurations that present virtual image information in multiple focal planes (for example, two or more) in order to be practical for a wide variety of use-cases without exceeding an acceptable allowance for vergence-accommodation mismatch.

Also, it would be desirable to have a new technique for providing a virtual object relative to a view of a user, so that the virtual object can be accurately placed with respect to the physical environment as viewed by the user. In some cases, if the virtual object is virtually placed with respect to the physical environment that is located far from the user, the virtual object may be offset or may “drift” away from its intended location. This may happen because the local coordinate frame with respect to the user, while correctly registered with respect to a feature in the physical environment, may not accurately align with other features in the physical environment that is further away from the user.

### SUMMARY

Methods and apparatuses for providing virtual content, such as virtual object, for display by one or more screens of one or more image display devices (worn by one or more users) are described herein. In some embodiments, the virtual content may be displayed so that it appears to be in a physical environment as viewed by a user through the screen. The virtual content may be provided based on one or more anchor points registered with respect to the physical environment. In some embodiments, the virtual content may be provided as a moving object, and the positions of the moving object may be based on one or more anchor points that are in close proximity to an action of the moving object. This allows the object to be accurately placed virtually with respect to the user (as viewed by the user through the screen the user is wearing) even if the object is far from the user. In gaming applications, such feature may allow multiple users to interact with the same object even if the users are relatively far apart. For example, in a gaming application, the virtual object may be virtually passed back-and-forth between users. The placement (positioning) of the virtual object based on anchor point proximity described herein prevents the issue of offset and drift, thus allowing the virtual object to be positioned accurately.

An apparatus for providing a virtual content in an environment in which a first user and a second user can interact with each other, comprises: a communication interface configured to communicate with a first display screen worn by the first user and/or a second display screen worn by the second user; and a processing unit, the processing unit configured to: obtain a first position of the first user, determine a first set of one or more anchor points based on the first position of the first user, obtain a second position of the second user, determine a second set of one or more anchor points based on the second position of the second user, determine one or more common anchor points that are in both the first set and the second set, and provide the virtual content for experience by the first user and/or the second user based on at least one of the one or more common anchor points.

Optionally, the one or more common anchor points comprise multiple common anchor points, and the processing unit is configured to select a subset of common anchor points from the multiple common anchor points.

Optionally, the processing unit is configured to select the subset of common anchor points to reduce localization error of the first user and the second user relative to each other.

Optionally, the one or more common anchor points comprise a single common anchor point.

Optionally, the processing unit is configured to position and/or to orient the virtual content based on the at least one of the one or more common anchor points.

Optionally, each of the one or more anchor points in the first set is a point in a persistent coordinate frame (PCF).

Optionally, the processing unit is configured to provide the virtual content for display as a moving virtual object in the first display screen and/or the second display screen.

Optionally, the processing unit is configured to provide the virtual object for display in the first display screen, such that the virtual object appears to be moving in a space that is between the first user and the second user.

Optionally, the one or more common anchor points comprise a first common anchor point and a second common anchor point; wherein processing unit is configured to provide the moving virtual object for display in the first display screen, such that the moving virtual object has a first object position with respect to the first display screen, and a second object position with respect to the first display screen; wherein the first object position of the moving virtual object is based on the first common anchor point; and wherein the second object position of the moving virtual object is based on the second common anchor point.

Optionally, the processing unit is configured to select the first common anchor point for placing the virtual object at the first object position based on where an action of the virtual object is occurring.

Optionally, the one or more common anchor points comprise a single common anchor point; wherein processing unit is configured to provide the moving virtual object for display in the first display screen, such that the moving virtual object has a first object position with respect to the first display screen, and a second object position with respect to the first display screen; wherein the first object position of the moving virtual object is based on the single common anchor point; and wherein the second object position of the moving virtual object is based on the single common anchor point.

Optionally, the one or more common anchor points comprise multiple common anchor points, and wherein the processing unit is configured to select one of the common anchor points for placing the virtual content in the first display screen.

Optionally, the processing unit is configured to select the one of the common anchor points for placing the virtual content by selecting the one of the common anchor points that is the closest to, or that is within a distance threshold from, an action of the virtual content.

Optionally, a position and/or a movement of the virtual content is controllable by a first handheld device of the first user.

Optionally, the position and/or the movement of the virtual content is also controllable by a second handheld device of the second user.

Optionally, the processing unit is configured to localize the first user and the second user to a same mapping information based on the one or more common anchor points.

Optionally, the processing unit is configured to cause the first display screen to display the virtual content so that the virtual content will appear to be in a spatial relationship with respect to a physical object in a surround environment of the first user.

Optionally, the processing unit is configured to obtain one or more sensor inputs; and wherein the processing unit is configured to assist the first user in accomplishing an objective involving the virtual content based on the one or more sensor inputs.

Optionally, the one or more sensor inputs indicates an eye gaze direction, an upper extremity kinematics, a body position, a body orientation, or any combination of the foregoing, of the first user.

Optionally, the processing unit is configured to assist the first user in accomplishing the objective by applying one or more limits on positional and/or angular velocity of a system component.

Optionally, the processing unit is configured to assist the first user in accomplishing the objective by gradually reducing a distance between the virtual content and another element.

Optionally, the processing unit comprises a first processing part that is in communication with the first display screen, and a second processing part that is in communication with the second display screen.

A method performed by an apparatus that is configured to provide a virtual content in an environment in which a first user wearing a first display screen and a second user wearing a second display screen can interact with each other, includes: obtaining a first position of the first user; determining a first set of one or more anchor points based on the first position of the first user; obtaining a second position of the second user; determining a second set of one or more anchor points based on the second position of the second user; determining one or more common anchor points that are in both the first set and the second set; and providing the virtual content for experience by the first user and/or the second user based on at least one of the one or more common anchor points.

Optionally, the one or more common anchor points comprise multiple common anchor points, and wherein the method further comprises selecting a subset of common anchor points from the multiple common anchor points.

Optionally, the subset of common anchor points is selected to reduce localization error of the first user and the second user relative to each other.

Optionally, the one or more common anchor points comprise a single common anchor point.

Optionally, the method further includes determining a position and/or an orientation for the virtual content based on the at least one of the one or more common anchor points.

Optionally, each of the one or more anchor points in the first set is a point in a persistent coordinate frame (PCF).

Optionally, the virtual content is provided for display as a moving virtual object in the first display screen and/or the second display screen.

Optionally, the virtual object is provided for display in the first display screen, such that the virtual object appears to be moving in a space that is between the first user and the second user.

Optionally, the one or more common anchor points comprise a first common anchor point and a second common anchor point; wherein the moving virtual object is provided for display in the first display screen, such that the moving virtual object has a first object position with respect to the first display screen, and a second object position with respect to the first display screen; wherein the first object position of the moving virtual object is based on the first common anchor point; and wherein the second object position of the moving virtual object is based on the second common anchor point.

Optionally, the method further includes selecting the first common anchor point for placing the virtual object at the first object position based on where an action of the virtual object is occurring.

Optionally, the one or more common anchor points comprise a single common anchor point; wherein the moving virtual object is provided for display in the first display screen, such that the moving virtual object has a first object position with respect to the first display screen, and a second object position with respect to the first display screen; wherein the first object position of the moving virtual object is based on the single common anchor point; and wherein the second object position of the moving virtual object is based on the single common anchor point.

Optionally, the one or more common anchor points comprise multiple common anchor points, and wherein the method further comprises selecting one of the common anchor points for placing the virtual content in the first display screen.

Optionally, the act of selecting comprises selecting one of the common anchor points that is the closest to, or that is within a distance threshold from, an action of the virtual content.

Optionally, a position and/or a movement of the virtual content is controllable by a first handheld device of the first user.

Optionally, the position and/or the movement of the virtual content is also controllable by a second handheld device of the second user.

Optionally, the method further includes localizing the first user and the second user to a same mapping information based on the one or more common anchor points.

Optionally, the method further includes displaying the virtual content by the first display screen, so that the virtual content will appear to be in a spatial relationship with respect to a physical object in a surround environment of the first user.

Optionally, the method further includes obtaining one or more sensor inputs; and assisting the first user in accomplishing an objective involving the virtual content based on the one or more sensor inputs.

Optionally, the one or more sensor inputs indicates an eye gaze direction, an upper extremity kinematics, a body position, a body orientation, or any combination of the foregoing, of the first user.

Optionally, the act of assisting the first user in accomplishing the objective comprises applying one or more limits on positional and/or angular velocity of a system component.

Optionally, the act of assisting the first user in accomplishing the objective comprises gradually reducing a distance between the virtual content and another element.

Optionally, the apparatus comprises a first processing part that is in communication with the first display screen, and a second processing part that is in communication with the second display screen.

A processor-readable non-transitory medium stores a set of instructions, an execution of which by a processing unit will cause a method to be performed, the processing unit being a part of an apparatus that is configured to provide a virtual content in an environment in which a first user and a second user can interact with each other, the method comprising: obtaining a first position of the first user; determining a first set of one or more anchor points based on the first position of the first user; obtaining a second position of the second user; determining a second set of one or more anchor points based on the second position of the second user; determining one or more common anchor points that are in both the first set and the second set; and providing the virtual content for experience by the first user and/or the second user based on at least one of the one or more common anchor points.

Additional and other objects, features, and advantages of the disclosure are described in the detail description, figures and claims.

### BRIEF DESCRIPTION OF THE DRAWINGS

The drawings illustrate the design and utility of various embodiments of the present disclosure. It should be noted that the figures are not drawn to scale and that elements of similar structures or functions are represented by like reference numerals throughout the figures. In order to better appreciate how to obtain the above-recited and other advantages and objects of various embodiments of the disclosure, a more detailed description of the present disclosures briefly described above will be rendered by reference to specific embodiments thereof, which are illustrated in the accompanying drawings. Understanding that these drawings depict only typical embodiments of the disclosure and are not therefore to be considered limiting of its scope, the disclosure will be described and explained with additional specificity and detail through the use of the accompanying drawings in which:

FIG. 1A illustrates an image display system having an image display device in accordance with some embodiments.

FIG. 1B illustrates an image display device displaying frames in multiple depth planes.

FIG. 2 illustrates a method in accordance with some embodiments.

FIG. 3 illustrates a method in accordance with some embodiments.

FIG. 4 illustrates a method in accordance with some embodiments.

FIGS. 5A-5L illustrate an example of two users interacting with each other in a virtual or augmented environment.

FIG. 6 illustrates an example of two users interacting with each other in a virtual or augmented environment based on a single anchor point.

FIGS. 7A-7D illustrate an example of two users interacting with each other in a virtual or augmented environment based on multiple anchor points.

FIG. 8 illustrates a method in accordance with some embodiments.

FIG. 9 illustrates a processing unit of an apparatus in accordance with some embodiments.

FIG. 10 illustrates a method in accordance with some embodiments.

FIG. 11 illustrates a specialized processing system in accordance with some embodiments.

### DETAILED DESCRIPTION

Various embodiments of the disclosure are directed to methods, apparatuses, and articles of manufacture for providing input for head-worn video image devices. Other objects, features, and advantages of the disclosure are described in the detailed description, figures, and claims.

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The description that follows pertains to an illustrative VR, AR, and/or MR system with which embodiments described herein may be practiced. However, it is to be understood that the embodiments also lends themselves to applications in other types of display systems (including other types of VR, AR, and/or MR systems), and therefore the embodiments are not to be limited to only the illustrative examples disclosed herein.

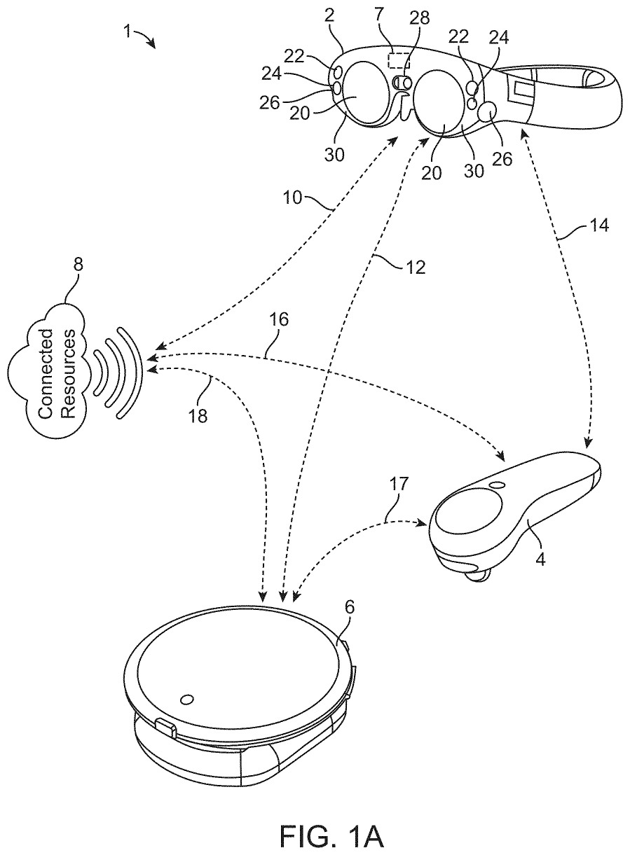

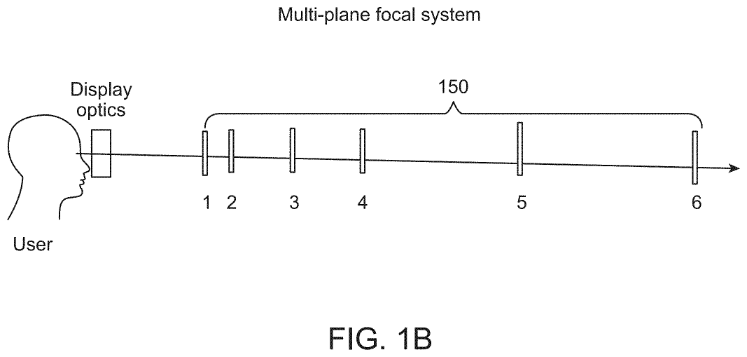

Referring to FIG. 1A, an augmented reality system 1 is illustrated featuring a head-worn viewing component (image display device) 2, a hand-held controller component 4, and an interconnected auxiliary computing or controller component 6 which may be configured to be worn as a belt pack or the like on the user. Each of these components may be operatively coupled (10, 12, 14, 16, 17, 18) to each other and to other connected resources 8 such as cloud computing or cloud storage resources via wired or wireless communication configurations, such as those specified by IEEE 802.11, Bluetooth®, and other connectivity standards and configurations. As described, for example, in U.S. patent application Ser. No. 14/555,585, Ser. No. 14/690,401, Ser. No. 14/331,218, Ser. No. 15/481,255, 62/627,155, 62/518,539, Ser. No. 16/229,532, Ser. No. 16/155,564, Ser. No. 15/413,284, Ser. No. 16/020,541, 62,702,322, 62/206,765, Ser. No. 15,597,694, Ser. No. 16/221,065, Ser. No. 15/968,673, 62/682,788, and 62/899,678 each of which is incorporated by reference herein in its entirety, various aspects of such components are described, such as various embodiments of the two depicted optical elements 20 through which the user may see the world around them along with visual components which may be produced by the associated system components, for an augmented reality experience. As illustrated in FIG. 1A, such a system 1 may also comprise various sensors configured to provide information pertaining to the environment around the user, including but not limited to various camera type sensors (such as monochrome, color/RGB, and/or thermal imaging components) (22, 24, 26), depth camera sensors 28, and/or sound sensors 30 such as microphones. There is a need for compact and persistently connected wearable computing systems and assemblies such as those described herein, which may be utilized to provide a user with the perception of rich augmented reality experiences.

The system 1 also includes an apparatus 7 for providing input for the image display device 2. The apparatus 7 will be described in further detail below. The image display device 2 may be a VR device, an AR device, a MR device, or any of other types of display devices. As shown in the figure, the image display device 2 includes a frame structure worn by an end user, a display subsystem carried by the frame structure, such that the display subsystem is positioned in front of the eyes of the end user, and a speaker carried by the frame structure, such that the speaker is positioned adjacent the ear canal of the end user (optionally, another speaker (not shown) is positioned adjacent the other ear canal of the end user to provide for stereo/shapeable sound control). The display subsystem is designed to present the eyes of the end user with light patterns that can be comfortably perceived as augmentations to physical reality, with high-levels of image quality and three-dimensional perception, as well as being capable of presenting two-dimensional content. The display subsystem presents a sequence of frames at high frequency that provides the perception of a single coherent scene.

In the illustrated embodiments, the display subsystem employs “optical see-through” display through which the user can directly view light from real objects via transparent (or semi-transparent) elements. The transparent element, often referred to as a “combiner,” superimposes light from the display over the user's view of the real world. To this end, the display subsystem comprises a partially transparent display or a complete transparent display. The display is positioned in the end user's field of view between the eyes of the end user and an ambient environment, such that direct light from the ambient environment is transmitted through the display to the eyes of the end user.

In the illustrated embodiments, an image projection assembly provides light to the partially transparent display, thereby combining with the direct light from the ambient environment, and being transmitted from the display to the eyes of the user. The projection subsystem may be an optical fiber scan-based projection device, and the display may be a waveguide-based display into which the scanned light from the projection subsystem is injected to produce, e.g., images at a single optical viewing distance closer than infinity (e.g., arm's length), images at multiple, discrete optical viewing distances or focal planes, and/or image layers stacked at multiple viewing distances or focal planes to represent volumetric 3D objects. These layers in the light field may be stacked closely enough together to appear continuous to the human visual subsystem (i.e., one layer is within the cone of confusion of an adjacent layer). Additionally or alternatively, picture elements may be blended across two or more layers to increase perceived continuity of transition between layers in the light field, even if those layers are more sparsely stacked (i.e., one layer is outside the cone of confusion of an adjacent layer). The display subsystem may be monocular or binocular.

The image display device 2 may also include one or more sensors mounted to the frame structure for detecting the position and movement of the head of the end user and/or the eye position and inter-ocular distance of the end user. Such sensors may include image capture devices (such as cameras), microphones, inertial measurement units, accelerometers, compasses, GPS units, radio devices, and/or gyros), or any combination of the foregoing. Many of these sensors operate on the assumption that the frame on which they are affixed is in turn substantially fixed to the user's head, eyes, and ears.

The image display device 2 may also include a user orientation detection module. The user orientation module detects the instantaneous position of the head of the end user (e.g., via sensors coupled to the frame) and may predict the position of the head of the end user based on position data received from the sensors. Detecting the instantaneous position of the head of the end user facilitates determination of the specific actual object that the end user is looking at, thereby providing an indication of the specific virtual object to be generated in relation to that actual object and further providing an indication of the position in which the virtual object is to be displayed. The user orientation module may also track the eyes of the end user based on the tracking data received from the sensors.

The image display device 2 may also include a control subsystem that may take any of a large variety of forms. The control subsystem includes a number of controllers, for instance one or more microcontrollers, microprocessors or central processing units (CPUs), digital signal processors, graphics processing units (GPUs), other integrated circuit controllers, such as application specific integrated circuits (ASICs), programmable gate arrays (PGAs), for instance field PGAs (FPGAs), and/or programmable logic controllers (PLUs).

The control subsystem of the image display device 2 may include a central processing unit (CPU), a graphics processing unit (GPU), one or more frame buffers, and a three-dimensional data base for storing three-dimensional scene data. The CPU may control overall operation, while the GPU may render frames (i.e., translating a three-dimensional scene into a two-dimensional image) from the three-dimensional data stored in the three-dimensional data base and store these frames in the frame buffers. One or more additional integrated circuits may control the reading into and/or reading out of frames from the frame buffers and operation of the image projection assembly of the display subsystem.

The apparatus 7 represents the various processing components for the system 1. In the figure, the apparatus 7 is illustrated as a part of the image display device 2. In other embodiments, the apparatus 7 may be implemented in the handheld controller component 4, and/or in the controller component 6. In further embodiments, the various processing components of the apparatus 7 may be implemented in a distributed subsystem. For example, the processing components of the apparatus 7 may be located in two or more of: the image display device 2, in the handheld controller component 4, in the controller component 6, or in another device (that is in communication with the image display device 2, the handheld controller component 4, and/or the controller component 6).

The couplings 10, 12, 14, 16, 17, 18 between the various components described above may include one or more wired interfaces or ports for providing wires or optical communications, or one or more wireless interfaces or ports, such as via RF, microwave, and IR for providing wireless communications. In some implementations, all communications may be wired, while in other implementations all communications may be wireless. Thus, the particular choice of wired or wireless communications should not be considered limiting.

Some image display systems (e.g., VR system, AR system, MR system, etc.) use a plurality of volume phase holograms, surface-relief holograms, or light guiding optical elements that are embedded with depth plane information to generate images that appear to originate from respective depth planes. In other words, a diffraction pattern, or diffractive optical element (“DOE”) may be embedded within or imprinted/embossed upon a light guiding optical element (“LOE”; e.g., a planar waveguide) such that as collimated light (light beams with substantially planar wavefronts) is substantially totally internally reflected along the LOE, it intersects the diffraction pattern at multiple locations and exits toward the user's eye. The DOEs are configured so that light exiting therethrough from an LOE are verged so that they appear to originate from a particular depth plane. The collimated light may be generated using an optical condensing lens (a “condenser”).

For example, a first LOE may be configured to deliver collimated light to the eye that appears to originate from the optical infinity depth plane (0 diopters). Another LOE may be configured to deliver collimated light that appears to originate from a distance of 2 meters (½ diopter). Yet another LOE may be configured to deliver collimated light that appears to originate from a distance of 1 meter (1 diopter). By using a stacked LOE assembly, it can be appreciated that multiple depth planes may be created, with each LOE configured to display images that appear to originate from a particular depth plane. It should be appreciated that the stack may include any number of LOEs. However, at least N stacked LOEs are required to generate N depth planes. Further, N, 2N or 3N stacked LOEs may be used to generate RGB colored images at N depth planes.

In order to present 3-D virtual content to the user, the image display system 1 (e.g., VR system, AR system, MR system, etc.) projects images of the virtual content into the user's eye so that they appear to originate from various depth planes in the Z direction (i.e., orthogonally away from the user's eye). In other words, the virtual content may not only change in the X and Y directions (i.e., in a 2D plane orthogonal to a central visual axis of the user's eye), but it may also appear to change in the Z direction such that the user may perceive an object to be very close or at an infinite distance or any distance in between. In other embodiments, the user may perceive multiple objects simultaneously at different depth planes. For example, the user may see a virtual dragon appear from infinity and run towards the user. Alternatively, the user may simultaneously see a virtual bird at a distance of 3 meters away from the user and a virtual coffee cup at arm's length (about 1 meter) from the user.

Multiple-plane focus systems create a perception of variable depth by projecting images on some or all of a plurality of depth planes located at respective fixed distances in the Z direction from the user's eye. Referring now to FIG. 1B, it should be appreciated that multiple-plane focus systems may display frames at fixed depth planes 150 (e.g., the six depth planes 150 shown in FIG. 1B). Although MR systems can include any number of depth planes 150, one exemplary multiple-plane focus system has six fixed depth planes 150 in the Z direction. In generating virtual content one or more of the six depth planes 150, 3-D perception is created such that the user perceives one or more virtual objects at varying distances from the user's eye. Given that the human eye is more sensitive to objects that are closer in distance than objects that appear to be far away, more depth planes 150 are generated closer to the eye, as shown in FIG. 1B. In other embodiments, the depth planes 150 may be placed at equal distances away from each other.

Depth plane positions 150 may be measured in diopters, which is a unit of optical power equal to the inverse of the focal length measured in meters. For example, in some embodiments, depth plane 1 may be ⅓ diopters away, depth plane 2 may be 0.3 diopters away, depth plane 3 may be 0.2 diopters away, depth plane 4 may be 0.15 diopters away, depth plane 5 may be 0.1 diopters away, and depth plane 6 may represent infinity (i.e., 0 diopters away). It should be appreciated that other embodiments may generate depth planes 150 at other distances/diopters. Thus, in generating virtual content at strategically placed depth planes 150, the user is able to perceive virtual objects in three dimensions. For example, the user may perceive a first virtual object as being close to him when displayed in depth plane 1, while another virtual object appears at infinity at depth plane 6. Alternatively, the virtual object may first be displayed at depth plane 6, then depth plane 5, and so on until the virtual object appears very close to the user. It should be appreciated that the above examples are significantly simplified for illustrative purposes. In another embodiment, all six depth planes may be concentrated on a particular focal distance away from the user. For example, if the virtual content to be displayed is a coffee cup half a meter away from the user, all six depth planes could be generated at various cross-sections of the coffee cup, giving the user a highly granulated 3-D view of the coffee cup.

In some embodiments, the image display system 1 (e.g., VR system, AR system, MR system, etc.) may work as a multiple-plane focus system. In other words, all six LOEs may be illuminated simultaneously, such that images appearing to originate from six fixed depth planes are generated in rapid succession with the light sources rapidly conveying image information to LOE 1, then LOE 2, then LOE 3 and so on. For example, a portion of the desired image, comprising an image of the sky at optical infinity may be injected at time 1 and the LOE retaining collimation of light (e.g., depth plane 6 from FIG. 1B) may be utilized. Then an image of a closer tree branch may be injected at time 2 and an LOE configured to create an image appearing to originate from a depth plane 10 meters away (e.g., depth plane 5 from FIG. 1B) may be utilized; then an image of a pen may be injected at time 3 and an LOE configured to create an image appearing to originate from a depth plane 1 meter away may be utilized. This type of paradigm can be repeated in rapid time sequential (e.g., at 360 Hz) fashion such that the user's eye and brain (e.g., visual cortex) perceives the input to be all part of the same image.

The image display system 1 may project images (i.e., by diverging or converging light beams) that appear to originate from various locations along the Z axis (i.e., depth planes) to generate images for a 3-D experience/scenario. As used in this application, light beams include, but are not limited to, directional projections of light energy (including visible and invisible light energy) radiating from a light source. Generating images that appear to originate from various depth planes conforms the vergence and accommodation of the user's eye for that image, and minimizes or eliminates vergence-accommodation conflict.

In some cases, in order to localize a user of a head-worn image display device with respect to the user's environment, a localization map of the environment is obtained. In some embodiments, the localization map may be stored in a non-transitory medium that is a part of the system 1. In other embodiments, the localization map may be received wirelessly from a database. After the localization map is obtained, real-time input image from the camera system of the image display device is then matched against the localization map to localize the user. For example corner features of the input image may be detected from the input image, and match against corner features of the localization map. In some embodiments, in order to obtain a set of corners as features from an image for use in localization, the image may first need to go through corner detection to obtain an initial set of detected corners. The initial set of detected corners is then further processed, e.g., go through non-maxima suppression, spatial binning, etc., in order to obtain a final set of detected corners for localization purposes. In some cases, filtering may be performed to identify a subset of detected corners in the initial set to obtain the final set of corners.

Also, in some embodiments, a localization map of the environment may be created by the user directing the image display device 2 at different directions (e.g., by turning his/her head while wearing the image display device 2). As the image display device 2 is pointed to different spaces in the environment, the sensor(s) on the image display device 2 senses characteristics of the environment, which characteristics may then be used by the system 1 to create a localization map. In one implementation, the sensor(s) may include one or more cameras and/or one or more depth sensors. The camera(s) provide camera images, which are processed by the apparatus 7 to identify different objects in the environment. Additionally or alternatively, the depth sensor(s) provide depth information, which are processed by the apparatus to determine different surfaces of objects in the environment.

In various embodiments, a user may be wearing an augmented reality system such as that depicted in FIG. 1A, which may also be termed a “spatial computing” system in relation to such system's interaction with the three-dimensional world around the user when operated. Such a system may comprise, for example, a head wearable display component 2, and may feature environmental sensing capabilities as described above and in the aforementioned incorporated by reference materials, such as cameras of various types which may be configured to map the environment around the user, or to create a “mesh” of such environment, comprising various points representative of the geometry of various objects within the environment around the user, such as walls, floors, chairs, and the like. The spatial computing system may be configured to map or mesh the environment around the user, and to run or operate software, such as that available from Magic Leap, Inc., of Plantation, Fla., which may be configured to utilize the map or mesh of the room to assist the user in placing, manipulating, visualizing, creating, and modifying various objects and elements in the three-dimensional space around the user. Referring back to FIG. 1A, the system may be operatively coupled to additional resources, such as other computing systems, by cloud or other connectivity configurations. One of the challenges in spatial computing relates to the utilization of data captured by various operatively coupled sensors (such as elements 22, 24, 26, 28 of the system of FIG. 1A) in making determinations useful and/or critical to the user, such as in computer vision and/or object recognition challenges that may, for example, relate to the three-dimensional world around a user.

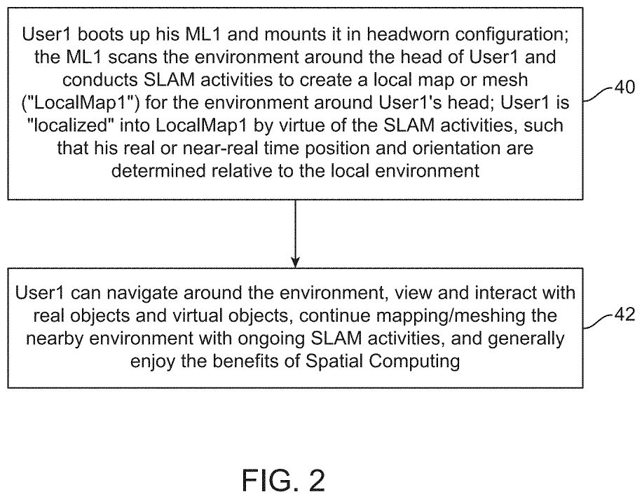

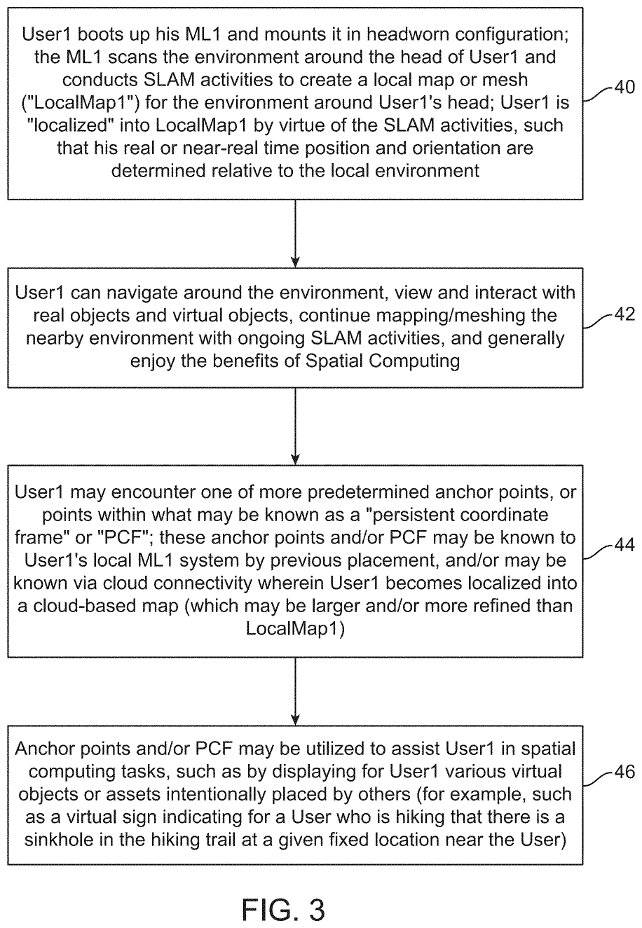

For example, referring to FIG. 2, in a typical spatial computing scenario is illustrated utilizing a system such as that illustrated in FIG. 1A (which also may be termed an “ML1”, representative of the Magic Leap One® system available from Magic Leap, Inc. of Plantation, Fla.). A first user (may be termed “User1”) boots up his or her ML1 system and mounts a headworn component 2 upon his or her head; the ML1 may be configured to scan the local environment around the head of User1 and conduct simultaneous localization and mapping (known as “SLAM”) activities with the sensors comprising the headworn component 2 to create a local map or mesh (in this scenario, may be termed “LocalMap1”) for the environment around User1's head; User1 may be “localized” into this LocalMap1 by virtue of the SLAM activities, such that his or her real or near-real time position and orientation are determined relative to the local environment 40. Referring again to FIG. 2, User1 may navigate around the environment, view and interact with real objects and virtual objects, continue mapping/meshing the nearby environment with ongoing SLAM activities, and generally enjoy the benefits of spatial computing 42 on his own. Referring to FIG. 3, additional steps and configuration may be added such that User1 may encounter one of more predetermined anchor points, or points within what may be known as a “persistent coordinate frame” or “PCF”; these anchor points and/or PCF may be known to User1's local ML1 system by previous placement, and/or may be known via cloud connectivity (i.e., by connected resources such as those illustrated in FIG. 1A, element 8, which may edge computing, cloud computing, and other connected resources) wherein User1 becomes localized into a cloud-based map (which may be larger and/or more refined than LocalMap1) 44. Referring again to FIG. 3, anchor points and/or PCF may be utilized to assist User1 in spatial computing tasks, such as by displaying for User1 various virtual objects or assets intentionally placed by others (for example, such as a virtual sign indicating for a User who is hiking that there is a sinkhole in the hiking trail at a given fixed location near the User) 46.

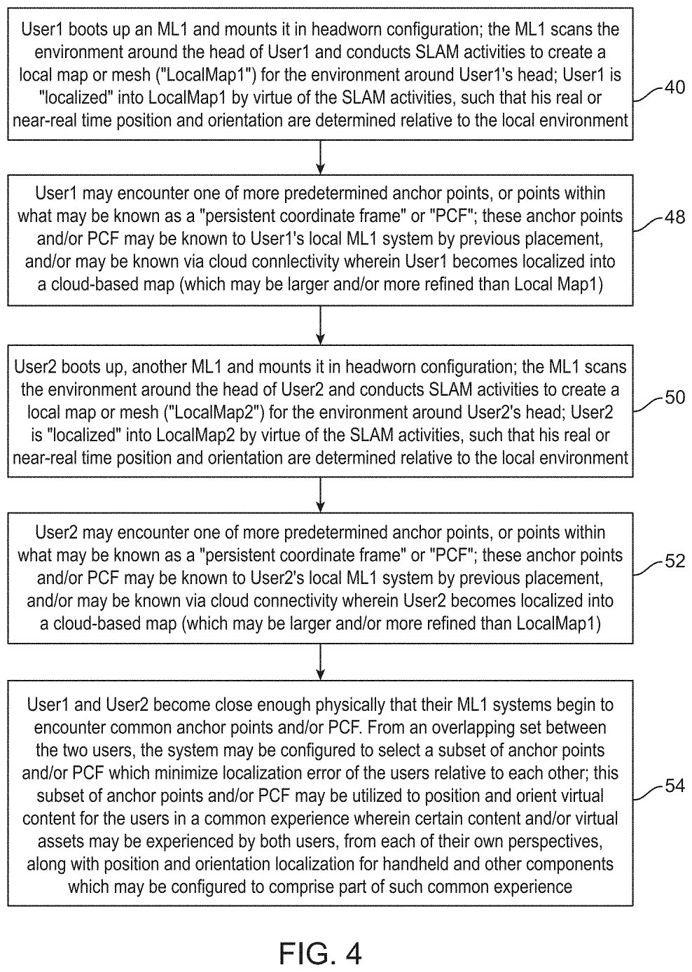

Referring to FIG. 4, a multi-user (or “multi-player” in the scenario of a game) configuration is illustrated wherein, similar as described above in reference to FIG. 3, User1 boots up an ML1 and mounts it in headworn configuration; the ML1 scans the environment around the head of User1 and conducts SLAM activities to create a local map or mesh (“LocalMap1”) for the environment around User1's head; User1 is “localized” into LocalMap1 by virtue of the SLAM activities, such that his real or near-real time position and orientation are determined relative to the local environment 40. User1 may encounter one of more predetermined anchor points, or points within what may be known as a “persistent coordinate frame” or “PCF”. These anchor points and/or PCF may be known to User1's local ML1 system by previous placement, and/or may be known via cloud connectivity wherein User1 becomes localized into a cloud-based map (which may be larger and/or more refined than LocalMap1) 48. A separate user, “User2”, may boot up another ML1 system and mount it in headworn configuration. This second ML1 system may scan the environment around the head of User2 and conducts SLAM activities to create a local map or mesh (“LocalMap2”) for the environment around User2's head; User2 is “localized” into LocalMap2 by virtue of the SLAM activities, such that his real or near-real time position and orientation are determined relative to the local environment 50. As with User1, User2 may encounter one of more predetermined anchor points, or points within what may be known as a “persistent coordinate frame” or “PCF”. These anchor points and/or PCF may be known to User2's local ML1 system by previous placement, and/or may be known via cloud connectivity wherein User2 becomes localized into a cloud-based map (which may be larger and/or more refined than LocalMap1 or LocalMap2) 52. Referring again to FIG. 4, User1 and User2 may become close enough physically that their ML1 systems begin to encounter common anchor points and/or PCF. From an overlapping set between the two users, the system, using resources such as cloud computing connected resources 8 may be configured to select a subset of anchor points and/or PCF which minimize localization error of the users relative to each other; this subset of anchor points and/or PCF may be utilized to position and orient virtual content for the users in a common experience wherein certain content and/or virtual assets may be experienced by both users, from each of their own perspectives, along with position and orientation localization for handheld 4 and other components which may be configured to comprise part of such common experience.

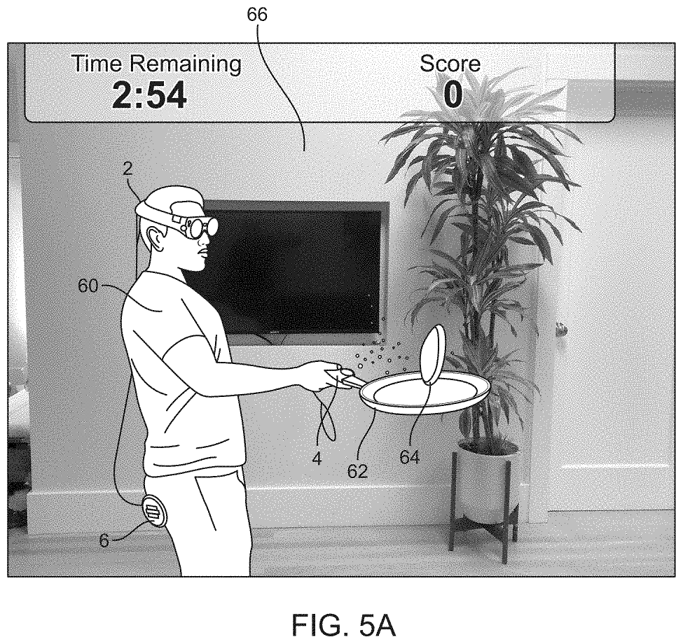

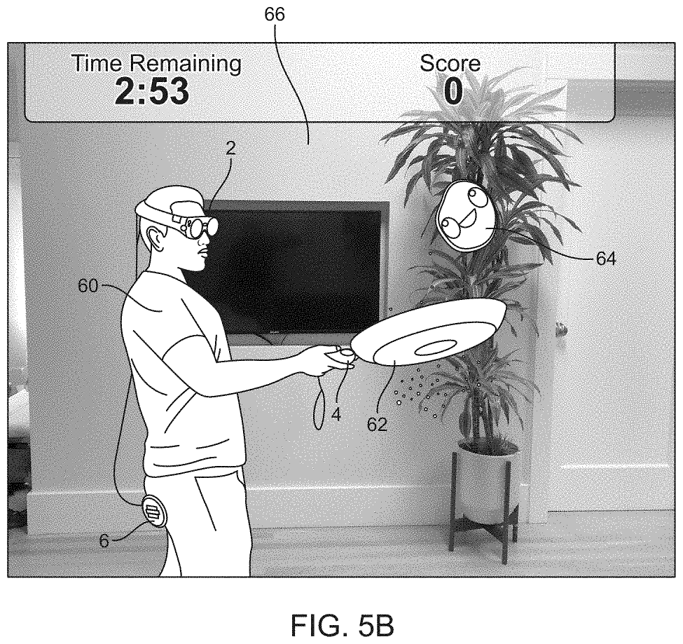

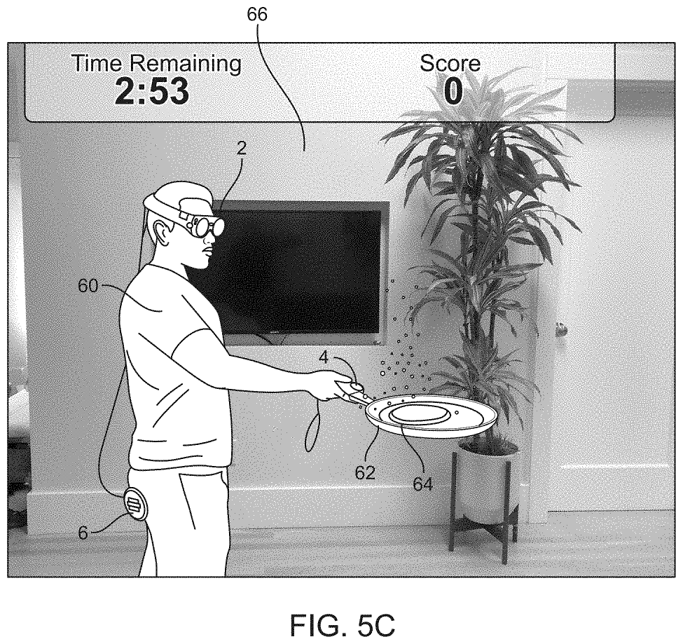

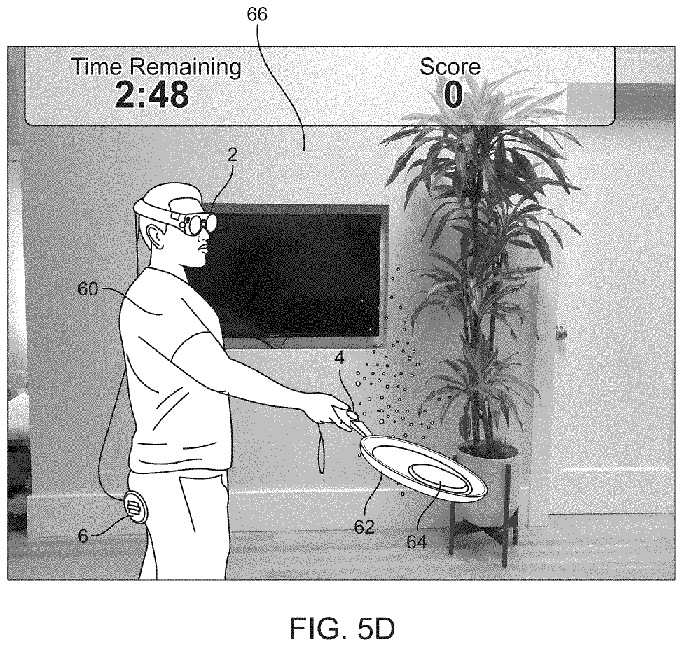

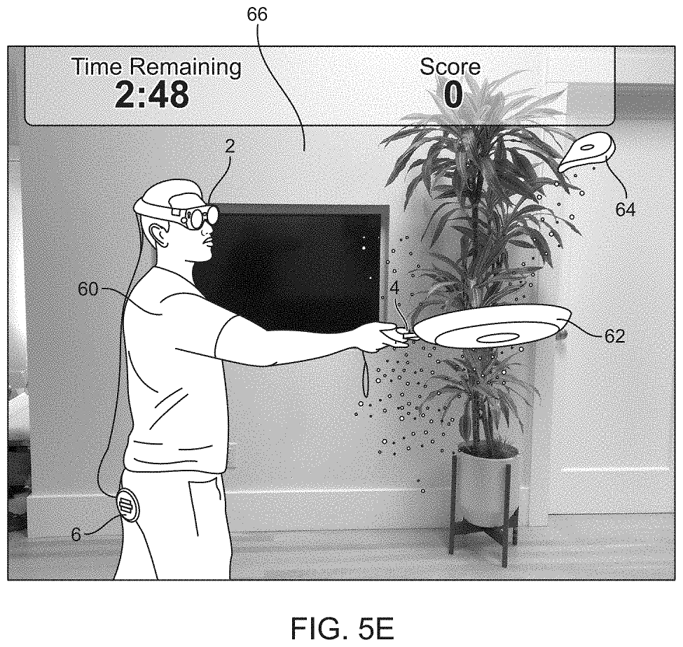

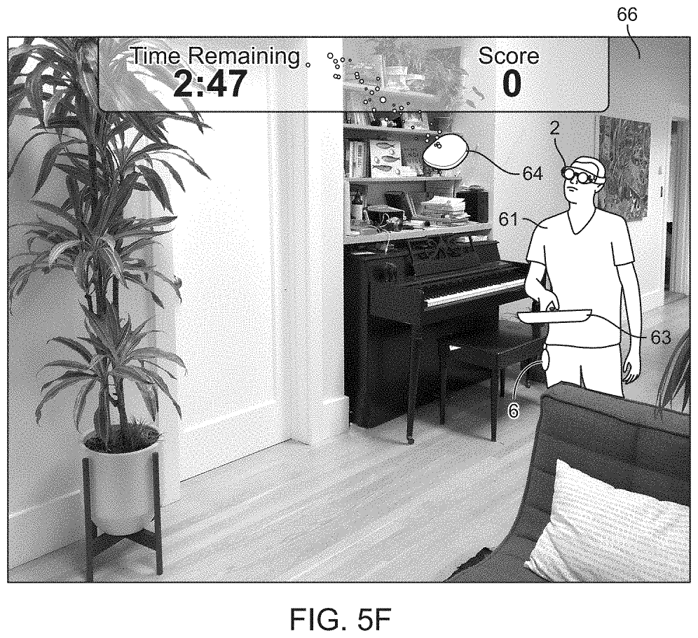

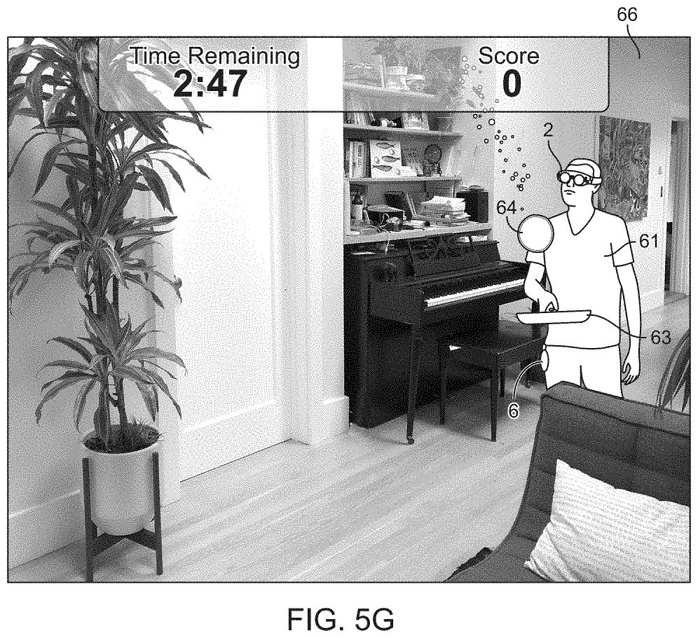

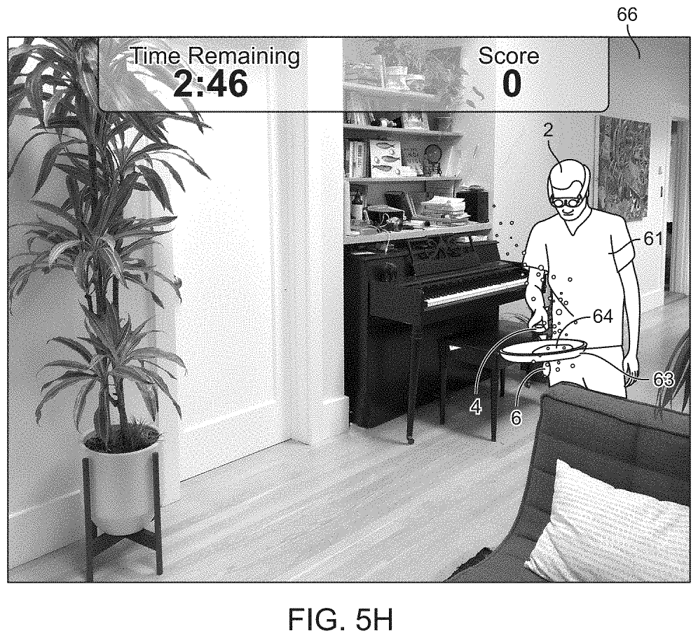

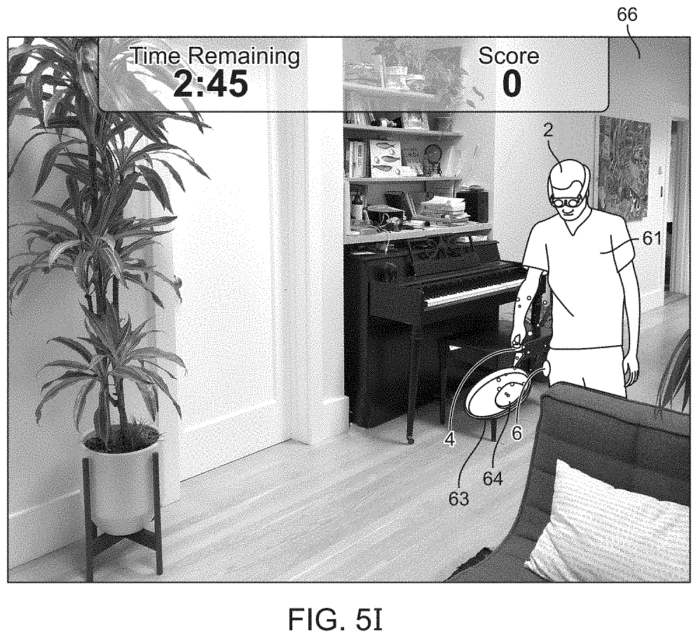

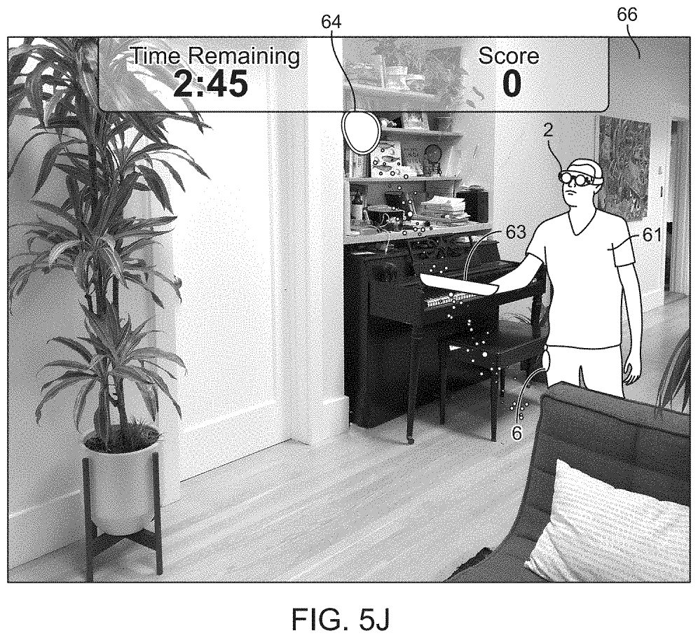

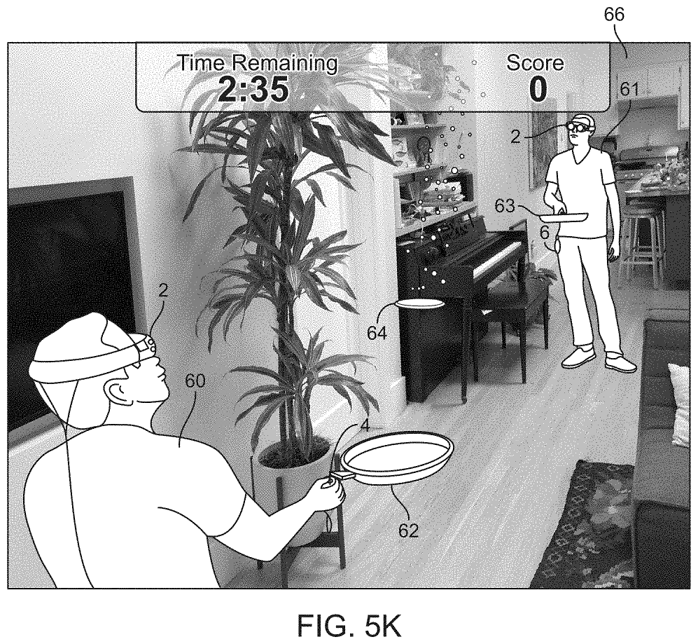

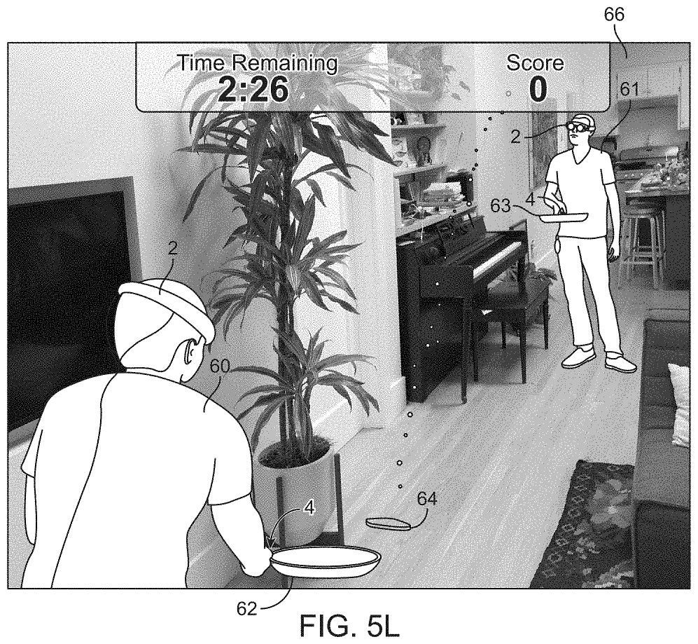

Referring to FIGS. 5A-5L, an exemplary common, collaborative, or multi-user experience is shown in the form of a pancake flipping game which may be available under the tradename “Pancake Pals” ™ from Magic Leap, Inc. of Plantation, Fla. Referring to FIG. 5A, a first user (may also be termed “User1”), element 60 is shown on one end of an office environment 66 wearing a head-worn component 2, an interconnected auxiliary computing or controller component 6, and holding a handheld component 4 comprising an ML1 system similar to that illustrated in FIG. 1A. User1's 60 system is configured to display for him a virtual frying pan element 62 that extends, in virtual form, from his handheld component 4 as though the handheld component 4 is the handle of the frying pan element 62. User1's 60 system is configured to reposition and reorient the virtual frying pan 62 as User1 60 reorients and repositions his handheld component. Both the headworn 2 and handheld 4 components may be tracked in terms of position and orientation relative to each other in real or near-real time utilizing tracking features of the system described in the aforementioned incorporated references, for example. The system may be configured to allow the virtual frying pan 62, or other elements controlled by the user, such as other virtual elements, or other actual elements (such as one of the user's two hands or perhaps an actual frying pan or paddle which may be configured to be trackable by the system) to interact with a pancake 64 virtual element with simulated physics, using, for example, softbody physics capabilities of environments such as Unity®, such that User1 can flip the pancake 64, land it in his pan 62, and/or throw or fling the virtual pancake 64 on a trajectory away from User1. The softbody physics capabilities may be configured to have the pancake wrap around any edges of the virtual frying pan 62, for example, and to fly in a trajectory and manner that an actual pancake might. Referring to FIG. 5B, the virtual pancake 64 may be configured to have animated characteristics, and to provide the user with the perception that the pancake 64 enjoys being flipped and/or landed, such as by awarding points, making sounds, music, and heart or rainbow visuals, and the like. FIG. 5C illustrates User1 60 successfully landing a flipped virtual pancake 64 in his virtual frying pan 62. FIG. 5D illustrates User1 60 preparing to launch the virtual pancake 64 forward of User1 60. FIG. 5E illustrates the launched virtual pancake 64 flying away from User1 60.

Referring to FIG. 5F, in a multi-user experience, such as that described above in reference to FIG. 4 wherein the system is configured to localize two players relative to each other in the same environment 66. Here User1 60 and User2 61 are depicted occupying two different ends of the same hallway of an office; refer ahead to FIGS. 5K and 5L to see views showing both users together, and as the virtual pancake 64 was launched in FIG. 5E by User1 60, the same virtual pancake 64 flies with a simulated physics trajectory toward User2 61, who also is utilizing an ML1 system with headworn 2, handheld 4, and compute pack 6 components to have his own virtual frying pan element 63 to be able to interact with the virtual pancake 64 using simulated physics. Referring to FIGS. 5G and 5H, User2 61 successfully lines up his virtual frying pan 63 and catches the virtual pancake 64; and referring to FIGS. 5I and 5J, User2 61 may fling the virtual pancake 64 back toward User1 60, as shown in FIG. 5K, wherein User1 seems to be lining up his virtual frying pan 62 for another successful virtual pancake 64 catch, or alternatively in FIG. 5L wherein User1 seems to have come up short with his virtual frying pan 62 positioning and orientation, such that the virtual pancake 64 appears to be headed for the floor. Thus, a multi-user or multi-player configuration is presented wherein two users may collaborate or interact together with various elements, such as virtual dynamic elements.

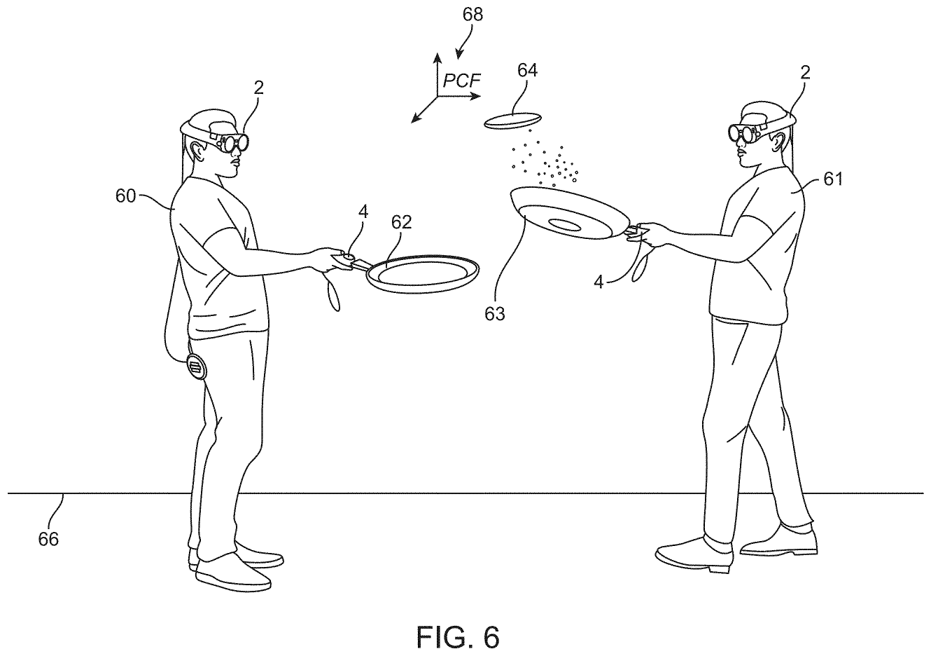

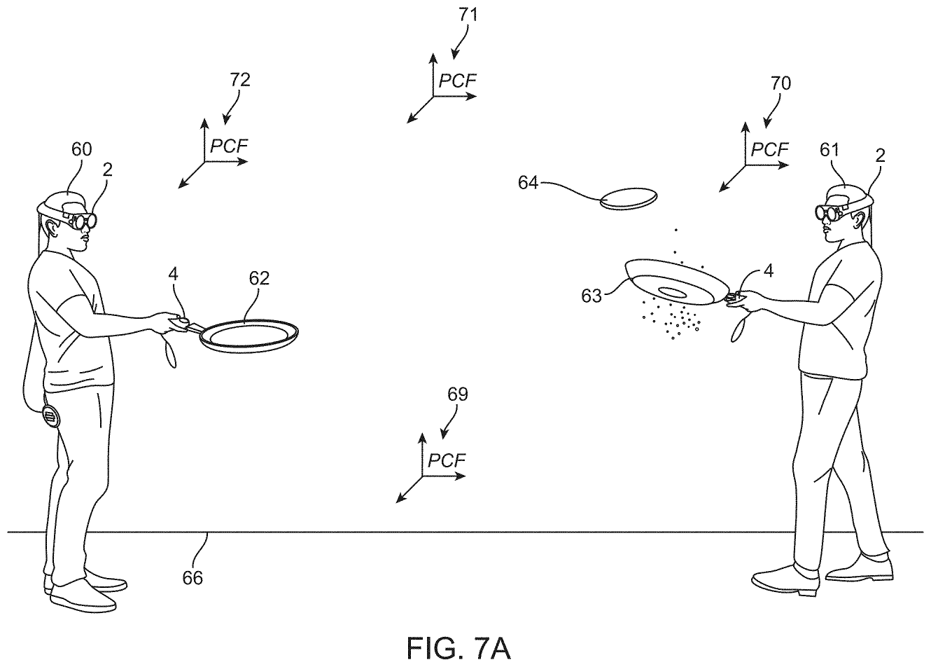

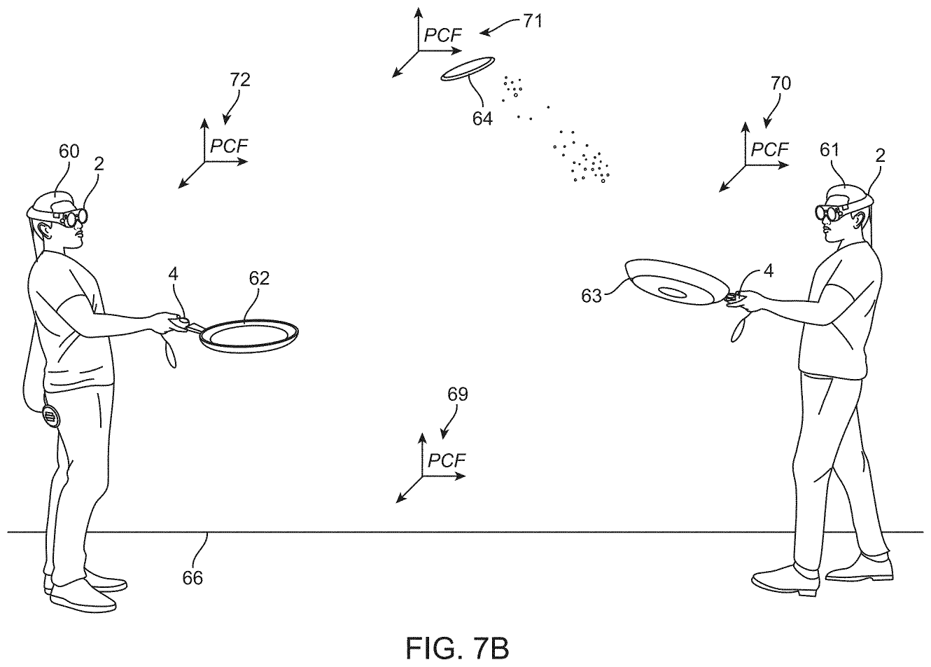

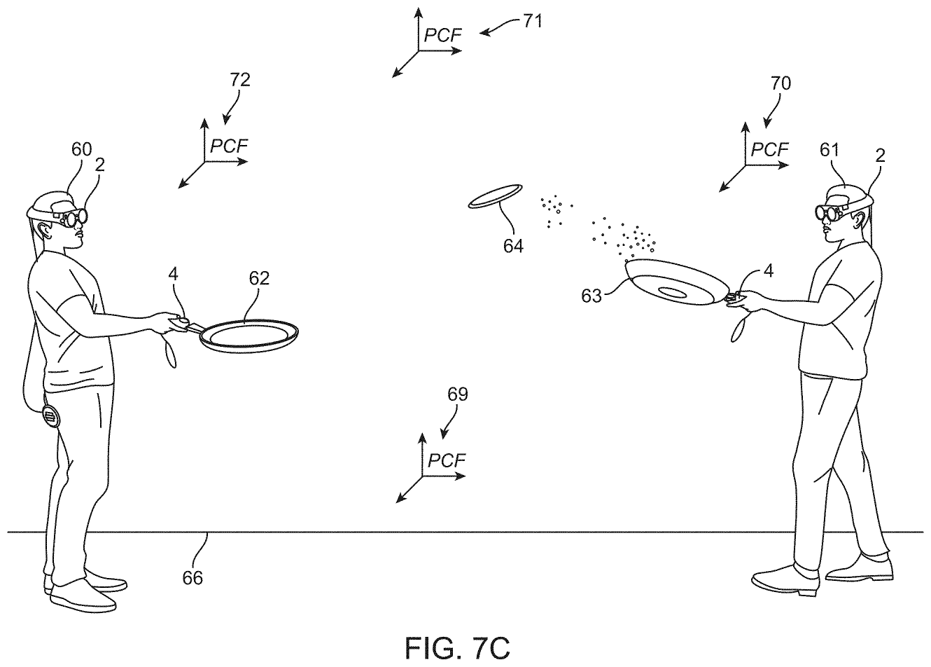

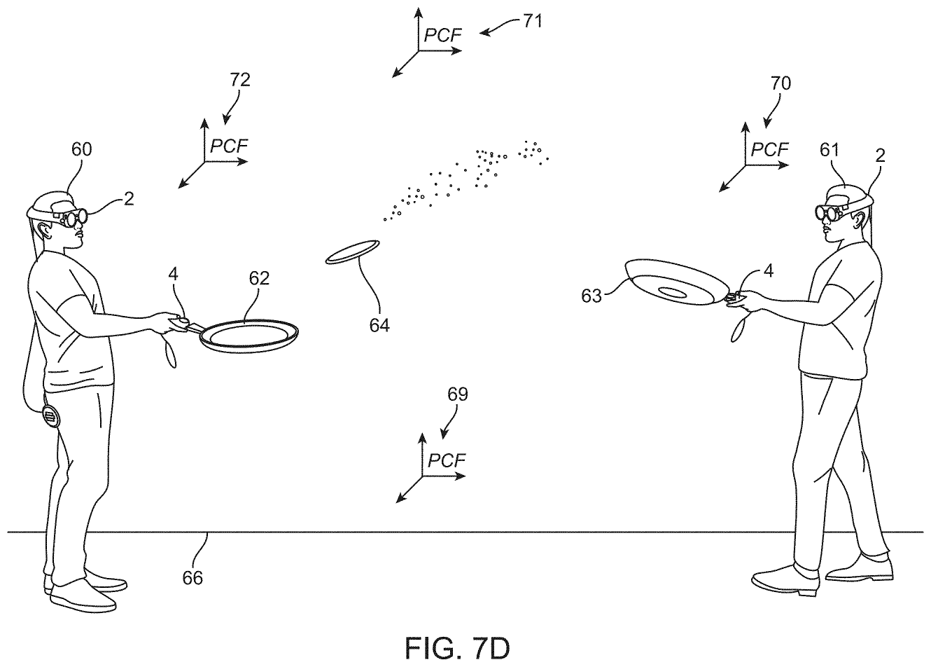

With regard to PCFs and anchor points, as described above, a local map, such as one created by a local user, may contain certain persistent anchor points or coordinate frames which may correspond to certain positions and/or orientations of various elements. Maps that have been promoted, stored, or created at the external resource 8 level, such as maps that have been promoted to cloud-based computing resources, may be merged with maps generated by other users. Indeed, a given user may be localized into a cloud or portion thereof, which, as described above, may be larger or more refined than the one generated in situ by the user. Further, as with the local map, a cloud map may be configured to contain certain persistent anchor points or PCFs which may correspond to real world positions and/or orientations, and which can be agreed upon by various devices in the same area or portion of a map or environment. When a user is localized (for example, after initially booting up and starting to scan with an ML1 system, or after loss of coordination with a local map, or after walking a certain distance within an environment such that SLAM activities assist in localizing the user), the user may be localized based upon nearby map features that correspond to features observable in the real world. Although persistent anchor points and PCFs may correspond to real-world positions, they also may be rigid with respect to each other until a map itself is updated. For example, if PCF-A and PCF-B are 5 meters apart, they may be configured to remain 5 meters apart even of the user re-localizes (i.e., the system may be configured such that individual PCFs don't move; only the user's estimated map alignment and the user's place within it do). Referring ahead to FIGS. 6 and 7A-7C, the further a user is from a high-confidence PCF (i.e., near the user's localization point), the larger the error will be in terms of position and orientation. For example, a two-degree error in PCF alignment on any axis may be associated with a 35-centimeter offset at 10 meters (tan(2deg)*10); this it is preferable to utilize persistent anchor points and PCFs which are close to the user or object being tracked, as discussed ahead in reference to FIGS. 6 and 7A-7C.

As noted in reference to FIG. 4, nearby users may be configured to receive the same nearby PCFs and persistent anchor point information. From an overlapping set of PCFs and persistent anchor points between two players, the system may be configured to select one or more PCFs and/or persistent anchor points which minimize average error, and these shared anchors/PCFs may be utilized to set the position/orientation of shared virtual content. In one embodiment, a host system, such as a cloud computing resource, may be configured to provide meshing/mapping information and transmit this to all users when starting a new collaborative session or game. The meshes may be positioned into appropriate places by local users using their common anchor with the host, and the system may be configured to specifically “cut” or “chop” off mesh portions which are vertically high—so that the players may have the perception of very large “headroom” or ceiling height (helpful for scenarios such as flipping pancakes between two users when maximum “air time” is desired). Various aspects of mapping or mesh based limitations such as ceiling height may be optionally bypassed or ignored (for example, in one embodiment, only the floor mesh/map may be utilized to confirm that a particular virtual element, such as a flying pancake, has struck the ground plane).

As noted above, softbody physics simulation may be utilized. In various embodiments, to prevent particles from becoming stuck when they end up between a virtual frying pan 62, 63 or other collider element, such collider elements may be configured to have extensions which grow on the opposite side of the pancake, so that collision may be resolved correctly.

The systems of the users, and associated connected resources 8 may be configured to allow users to start up games through associated social network resources (such as a predetermined group of friends who also have ML1 systems), and by geographical location of such users. For example, when a particular user is looking to play a game as illustrated in FIGS. 5A-5L, the associated systems may be configured to automatically curtail selection of a playing partner to those in a particular user's social network who are in the same building or in the same room.

Referring back to FIGS. 5A-5L, the system may be configured to only deal with one virtual pancake 64 at a time, such that computing efficiencies may be gained (i.e., the entire game state may be packed into a single packet. In various embodiments, the player/user nearest a given virtual pancake 64 at any point in time may be given authority over such virtual pancake 64, meaning that they control where it is for other users). In various embodiments, the networked state, update physics, and rendering all at update frequencies in the range of 60 Hz each, which is selected to keep visual presentation consistent even when crossing authority boundaries (i.e., from authority over pancake of one user to another user). In various embodiments, Tnet configurations (packet-switched point to point system area network) may be utilized, along with some custom packet configuration and other more standard packet configurations such as those described in known RFC publications.

Referring to FIG. 6, two users (User1 60, User2 61) are positioned in the same local environment 66 quite close in proximity to each other with one PCF 68 located immediately between them. With such a configuration and only one reliable PCF 68, a game such as that illustrated in FIGS. 5A-5L may be conducted, with both users localized to the same mapping information by virtue of the same PCF. Referring to FIGS. 7A-7C, however, the users (User1 60, User2 61) are positioned relatively far apart, but thankfully there is a plurality of PCFs (69, 70, 71, 72) positioned between the two users. As noted above, to prevent offsets and/or drift, it is desirable to use a PCF that is close to the action as possible. Thus, in FIG. 7A, with User2 61 flipping/launching and generally having proximity and control of the virtual pancake 64, a nearby PCF (such as 70, 69, or both 69 and 70, for examples) may be utilized. Referring to FIG. 7B, as the virtual pancake 64 flies between the two users (61, 60), PCFs most proximate to the flying virtual pancake (70, 71, or both 70 and 71, for examples) may be utilized. In the case of a lower virtual pancake toss as shown in FIG. 7C, other PCFs most proximate to the flying virtual pancake (69, 70, or both 69 and 70, for examples) may be utilized. Referring to FIG. 7D, as the virtual pancake (64) continues its trajectory toward User1 (60), PCFs most proximate to the flying virtual pancake (69, 72, or both 69 and 72, for examples) may be utilized. Thus, a dynamic PCF selection configuration may assist with minimizing drift and maximizing accuracy.

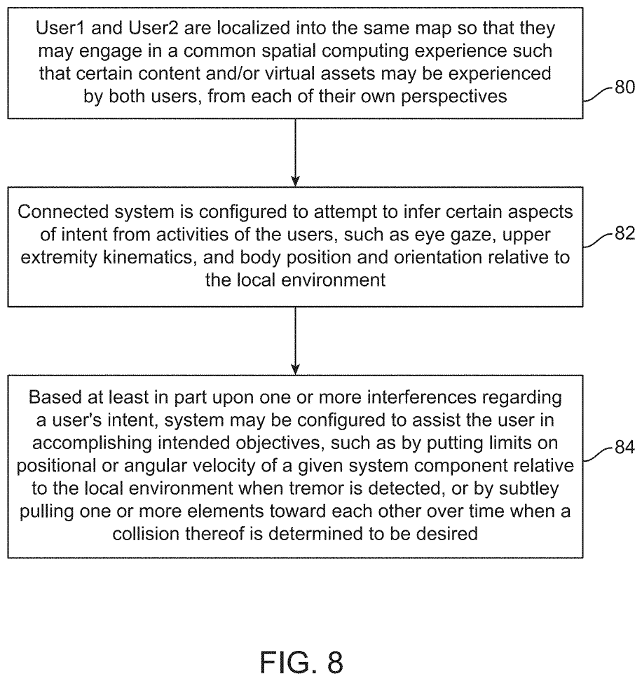

Referring to FIG. 8, a User1 and User2 may be localized into the same map so that they may engage in a common spatial computing experience such that certain content and/or virtual assets may be experienced by both users, from each of their own perspectives 80. A connected system, such as the local computing capabilities resident within the ML1 systems of the users, or such as certain cloud computing resources which may be interconnected 8, may be configured to attempt to infer certain aspects of intent from activities of the users, such as eye gaze, upper extremity kinematics, and body position and orientation relative to the local environment 82. For example, in one embodiment, the system may be configured to utilize captured gaze information of a first user to infer certain destinations for flinging a virtual element such as a pancake 64, such as the approximate location of a second user that the first user may be trying to target; similarly the system may be configured to infer targeted or other variables from the upper extremity position, orientation, velocity, and/or angular velocity. The information utilized to assist the user may be from real or near-real time sampling, or may be based upon sampling from a larger time domain, such as the playing or participating history of a particular user (for example, convolutional neural network (“CNN”) configurations, such as those disclosed in the aforementioned incorporated references, may be utilized to understand that a particular user always glances in a particular way, or always moves his or her arms in a particular way, when trying to hit a particular target or in a particular way; such configurations may be utilized to assist a user). Based at least in part upon one or more interferences regarding a user's intent, system may be configured to assist the user in accomplishing intended objectives 84. For example, in one embodiment, the system may be configured to place functional limits on positional or angular velocity of a given system component relative to the local environment when tremor is detected in a user's hands or arms (i.e., to reduce aberrant impacts of the tremor and thereby smooth out the instructions of that user to the system), or by subtly pulling one or more elements toward each other over time when a collision thereof is determined to be desired (i.e., in the example of a small child with relatively un-developed gross motor skills, the system may be configured to assist the child in aiming or moving, such that the child is more successful at the game or use-case; for example, for a child who continually misses catching a virtual pancake 64 by placing his virtual frying pan 62 too far to the right, the system may be configured to guide the pancake toward the pan, or the pan toward the pancake, or both).

In various other embodiments, the system may be configured to have other interactivity with the local actual world. For example, in one embodiment, a user playing a game as illustrated in FIGS. 5A-5L may be able to intentionally slam a virtual pancake 64 toward a wall, such that if the trajectory is direct enough with sufficient velocity, that virtual pancake sticks to that wall for the remainder of the game, or even permanently as part of the local mapping information or as associated with a nearby PCF.

Processing Unit

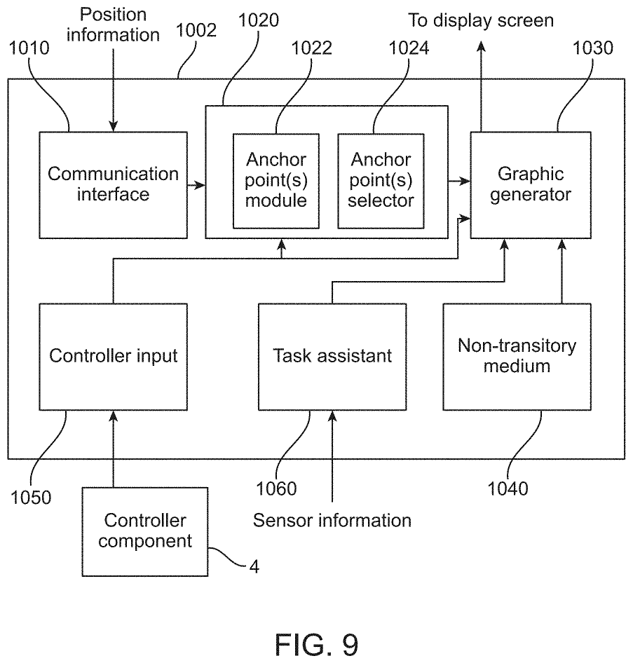

FIG. 9 illustrates a processing unit 1002 in accordance with some embodiments. The processing unit 1002 may be an example of the apparatus 7 described herein in some embodiments. In other embodiments, the processing unit 1002 or any part of the processing unit 1002 may be implemented using separate devices that are in communication with each other. As shown in the figure, the processing unit 1002 includes a communication interface 1010, a positioner 1020, a graphic generator 1030, a non-transitory medium 1040, a controller input 1050, and a task assistant 1060. In some embodiments, the communication interface 1010, the positioner 1020, the graphic generator 1030, the non-transitory medium 1040, the controller input 1050, the task assistant 1060, or any combination of the foregoing, may be implemented using hardware. By means of non-limiting examples, the hardware may include one or more FPGA processors, one or more ASIC processors, one or more signal processors, one or more math processors, one or more integrated circuits, or any combination of the foregoing. In some embodiments, any components of the processing unit 1102 may be implemented using software.

In some embodiments, the processing unit 1002 may be implemented as separate components that are communicatively coupled together. For example, the processing unit 1002 may have a first substrate carrying the communication interface 1010, the positioner 1020, the graphic generator 1030, the controller input 1050, the task assistant 1060, and another substrate carrying the non-transitory medium 1040. As another example, all of the components of the processing unit 1002 may be carried by a same substrate. In some embodiments, any, some, or all of the components of the processing unit 1002 may be implemented at the image display device 2. In some embodiments, any, some, or all of the components of the processing unit 1002 may be implemented at a device that is away from the image display device 2, such as at the handheld control component 4, the control component 6, a cell phone, a server, etc. In further embodiments, the processing unit 1002, or any of the components of the processing unit 1002 (such as the positioner 1020), may be implemented at different display devices worn by different respective users, or may be implemented at different devices associated with (e.g., in close proximity with) different respective users.

The processing unit 1002 is configured to receive position information (e.g., from sensors at the image display device 2, or from an external device) and/or control information from the controller component 4, and to provide virtual content for display in the screen of the image display device 2 based on the position information and/or the control information. For example, as illustrated with reference to FIGS. 5A-5L, the position information may indicate a position of the user 60, and the control information from the controller 4 may indicate a position of the controller 4 and/or an action being performed by the user 60 via the controller 4. In such cases, the processing unit 1002 generates an image of the virtual object (e.g., the pancake 64 in the above example) based on the position of the user 60 and the control information from the controller 4. In the one example, the control information indicates a position of the controller 4. In such cases, the processing unit 1002 generates the image of the pancake 64 so that the position of the pancake 64 is in relation to the position of the controller 4 (like that shown in FIG. 5D)—e.g., movement of the pancake 64 will follow a movement of the controller 4. In another example, if the user 60 performs a maneuver using the controller 4, such as tossing the virtual pancake 64 using the controller 4, the control information will include information regarding a movement direction of the controller 4, and a speed and/or an acceleration associated with the movement. In such cases, the processing unit 1002 then generates graphics indicating a movement of the virtual pancake 64 (like that shown in FIGS. 5E-5G). The movement may be along a movement trajectory that is calculated by the processing unit 1002 based on a position of where the pancake 64 leaves the virtual frying pan 63, and also based on a movement model (which receives the movement direction of the controller 4, and speed and/or acceleration of the controller 4, as inputs). The movement model will be described in further detail herein.

Returning to FIG. 9, the communication interface 1010 is configured to receive position information. As used in this specification, the term “position information” refers to any information representing a position of an entity or any information that can be used to derive a position of the entity. In some embodiments, the communication interface 1010 is communicatively coupled to a camera and/or depth sensor(s) of the image display device 2. In such embodiments, the communication interface 1010 receives images directly from the camera, and/or depth signals from the depth sensor(s). In some embodiments, the communication interface 1010 may be coupled to another device, such as another processing unit, which processes images from a camera, and/or processes depth signals from the depth sensor(s), before passing them as position information to the communication interface 1010. In other embodiments, the communication interface 1010 may be configured to receive GPS information, or any information that can be used to derive a position. Also, in some embodiments, the communication interface 1010 may be configured to obtain the position information output wirelessly or via physical conductive transmission line(s).

In some embodiments, if there are different sensors at the image display device 2 for providing different types of sensor outputs, the communication interface 1010 of the processing unit 1002 may have different respective sub-communication interfaces for receiving the different respective sensor outputs. In some embodiments, the sensor output may include image(s) captured by a camera at the image display device 2. Alternatively or additionally, the sensor output may include distance data captured by depth sensor(s) at the image display device 2. The distance data may be data generated based on time-of-flight technique. In such cases, a signal generator at the image display device 2 transmits a signal, and the signal reflects off from an object in an environment around the user. The reflected signal is received by a receiver at the image display device 2. Based on the time it takes for the signal to reach the object and to reflect back to the receiver, the sensor or the processing unit 1002 may then determine a distance between the object and the receiver. In other embodiments, the sensor output may include any other data that can be processed to determine a location of an entity (the user, an object, etc.) in the environment.

The positioner 1020 of the processing unit 1002 is configured to determine a position of the user of the image display device, and/or to determine position of a virtual object to be displayed in the image display device. In some embodiments, the position information received by the communication interface 1010 may be sensor signals, and the positioner 1020 is configured to process the sensor signals to determine a position of the user of the image display device. For example, the sensor signals may be camera images captured by one or more cameras of the image display device. In such cases, the positioner 1020 of the processing unit 1002 is configured to determine a localization map based on the camera images, and/or to match features in a camera image with features in a created localization map for localization of the user. In one implementation, the positioner 1020 is configured to perform the actions described with reference to FIG. 2 and/or FIG. 3 for localization of the user. In other embodiments, the position information received by the communication interface 1010 may already indicate a position of the user. In such cases, the positioner 1020 then uses the position information as the position of the user.

As shown in FIG. 9, the positioner 1020 includes an anchor point(s) module 1022 and an anchor point(s) selector 1024. The anchor point(s) module 1022 is configured to determine one or more anchor points, which may be utilized by the processing unit 1002 to localize the user, and or to place a virtual object with respect to an environment surround the user. In some embodiments, the anchor points may be points in a localization map, wherein each point in the localization map may be a feature (e.g., corner, edge, an object, etc.) identified in the physical environment. Also, in some embodiments, each anchor point may be a persistent coordinate frame (PCF) determined previously or in a current session. In some embodiments, the communication interface 1010 may receive the previously determined anchor point(s) from another device. In such cases, the anchor point(s) module 1022 may obtain the anchor point(s) by receiving the anchor point(s) from the communication interface 1010. In other embodiments, the anchor point(s) may be stored in the non-transitory medium 1040. In such cases, the anchor point(s) module 1022 may obtain the anchor point(s) by retrieving the anchor point(s) from the non-transitory medium 1040. In further embodiments, the anchor point(s) module 1022 may be configured to determine the anchor point(s) in a map creation session. In the map creation session, the user wearing the image display device walks around in an environment and/or orient the image display device at different viewing angles so that the camera(s) of the image display device captures images of different features in the environment. The processing unit 1002 may then perform feature identification to identify one or more features in the environment for use as anchor point(s). In some embodiments, anchor points for a certain physical environment were already determined in a previous session. In such cases, when the user enters the same physical environment, the camera(s) at the image display device being worn by the user will capture images of the physical environment. The processing unit 1002 may identify features in the physical environment, and see if one or more of the features match with the previously determined anchor points. If so, then the matched anchor points will be made available by the anchor point(s) module 1022, so that the processing unit 1002 can use those anchor point(s) for user localization and/or for placement of virtual content.

Also, in some embodiments, as the user moves around in the physical environment, the anchor point(s) module 1022 of the processing unit 1002 will identify additional anchor point(s). For example, when the user is at a first position in an environment, the anchor point(s) module 1022 of the processing unit 1002 may identify anchor points AP1, AP2, AP3 that are in close proximity to the first position of the user in the environment. If the user moves from a first position to a second position in the physical environment, the anchor point(s) module 1022 of the processing unit 1002 may identify anchor points AP3, AP4, AP5 that are in close proximity to the second position of the user in the environment.

In addition, in some embodiments, the anchor point(s) module 1022 is configured to obtain anchor point(s) associated with multiple users. For example, two users in the same physical environment may be standing far apart from each other. The first user may be at a first location with a first set of anchor points associated therewith. Similarly, the second user may be at a second location with a second set of anchor points associated therewith. Because the two users are far from each other, initially, the first set and the second set of anchor points may not have any overlap. However, when one or both of the users move towards each other, the makeup of the anchor points in the respective first and second sets will change. If they are close enough, the first and second sets of the anchor points will begin to have overlap(s).

The anchor point(s) selector 1024 is configured to select a subset of the anchor points (provided by the anchor point(s) module 1022) for use by the processing unit 1002 to localize the user, and or to place a virtual object with respect to an environment surround the user. In some embodiments, if the anchor point(s) module 1022 provides multiple anchor points that are associated with a single user, and there is no other user involved, then the anchor point(s) selector 1024 may select one or more of the anchor points for localization of the user, and/or for placement of virtual content with respect to the physical environment. In other embodiments, the anchor point(s) module 1022 may provide multiple sets of anchor points that are associated with different respective users (e.g., users wearing respective image display devices), who desire to virtually interact with each other in the same physical environment. In such cases, the anchor point(s) selector 1024 is configure to select one or more common anchor points that are in common among the different sets of anchor points. For example, as shown in FIG. 6, one common anchor point 68 may be selected for allowing the users 60, 61 to interact with the same virtual content (the pancake 64). FIG. 7A shows another example in which four common anchor points 69, 70, 71, 72 are selected for allowing the users 60, 61 to interact with a virtual content (the pancake 64). The processing unit 1002 may then utilize the selected common anchor point(s) for placement of virtual content, so that the users can interact with the virtual content in the same physical environment.

In some embodiments, the anchor point(s) selector 1024 may be configured to perform the actions described with reference to FIG. 4.

Returning to FIG. 9, the controller input 1050 of the processing unit 1002 is configured to receive input from the controller component 4. The input from the controller component 4 may be position information regarding a position and/or orientation of the controller component 4, and/or control information based on user's action performed via the controller component 4. By means of non-limiting examples, the control information from the controller component 4 may be generated based on the user translating the controller component 4, rotating the controller component 4, pressing one or more buttons on the controller component 4, actuating a knob, a trackball, or a joystick on the controller component 4, or any combination of the foregoing. In some embodiments, the user input is utilized by the processing unit 1002 to insert and/or to move the virtual object being presented in the screen of the image display device 2. For example, if the virtual object is the virtual pancake 64 described with reference to FIGS. 5A-5L, the handheld controller component 4 may be manipulated by the user to catch the virtual pancake 64, to move the virtual pancake 64 with the frying pan 62, and/or to throw the virtual pancake 64 away from the frying pan 62 so that the virtual pancake 64 will appear to be moving in the real environment as viewed by the user through the screen of the image display device 2. In some embodiments, the handheld controller component 4 may be configured to move the virtual object in the two-dimensional display screen so that the virtual object will appear to be in motion in a virtual three-dimensional space. For example, in addition to moving the virtual object up, down, left, and right, the handheld controller component 4 may also move the virtual object in and out of a vision depth of the user.

The graphic generator 1030 is configured to generate graphics for display on the screen of the image display device 2 based at least in part on an output from the positioner 1020 and/or output from the controller input 1050. For example, the graphic generator 1030 may control the screen of the image display device 2 to display a virtual object such that the virtual object appears to be in the environment as viewed by the user through the screen. By means of non-limiting examples, the virtual object may be a virtual moving object (e.g., a ball, a shuttle, a bullet, a missile, a fire, a heatwave, an energy wave), a weapon (e.g., a sword, an axe, a hammer, a knife, a bullet, etc.), any object that can be found in a room (e.g., a pencil, paper ball, cup, chair, etc.), any object that can be found outside a building (e.g., a rock, a tree branch, etc.), a vehicle (e.g., a car, a plane, a space shuttle, a rocket, a submarine, a helicopter, a motorcycle, a bike, a tractor, an all-terrain-vehicle, a snowmobile, etc.), etc. Also, in some embodiments, the graphic generator 1030 may generate an image of the virtual object for display on the screen such that the virtual object will appear to be interacting with the real physical object in the environment. For example, the graphic generator 1030 may cause the screen to display the image of the virtual object in moving configuration so that the virtual object appears to be moving through a space in the environment as viewed by the user through the screen of the image display device 2. Also, in some embodiments, the graphic generator 1030 may cause the screen to display the image of the virtual object so that the virtual object appears to be deforming or damaging the physical object in the environment, or appears to be deforming or damaging another virtual object, as viewed by the user through the screen of the image display device 2. In some cases, such may be accomplished by the graphic generator 1030 generating an interaction image, such as an image of a deformation mark (e.g., a dent mark, a fold line, etc.), an image of a burnt mark, an image showing a heat-change, an image of a fire, an explosion image, a wreckage image, etc., for display by the screen of the image display device 2.

As mentioned above, in some embodiments, the graphic generator 1030 may be configured to provide a virtual content as a moving virtual object, so that the virtual object appears to be moving in a three-dimensional space of the physical environment surround the user. For example, the moving virtual object may be the flying pancake 64 described with reference to FIGS. 5A-5L. In some embodiments, the graphic generator 1030 may be configured to generate graphics of the flying pancake 64 based on a trajectory model, and also based on one or more anchor point(s) provided by the anchor point(s) module 1022 or the anchor point(s) selector 1024. For example, the processing unit 1002 may determine an initial trajectory for the flying pancake 64 based on the trajectory model, wherein the initial trajectory indicates where the action of the flying pancake 64 is desired to be. The graphic generator 1030 then generates a sequence of images of the pancake 64 to form a video of the pancake 64 flying through the air in correspondence with the initial trajectory (e.g., following the initial trajectory as much as possible). The position of each image of the pancake 64 to be presented in the video may be determined by the processing unit 1002 based on a proximity of an action of the pancake 64 with respect to one or more nearby anchor points. For example, as discussed with reference to FIG. 7A, when the action of the pancake 64 is in close proximity to anchor points 69, 70, one or both of the anchor points 69, 70 may be utilized by the graphic generator 1030 to place the pancake 64 at a desired position with respect to the display screen, so that when the users 60, 61 view the pancake 64 in relation to the physical environment, the pancake 64 will be at the correct position with respect to the physical environment. As shown in FIG. 7B, when the pancake 64 is further along its trajectory, the action of the pancake 64 is in close proximity to anchor points 70, 71. In such case, one or both of the anchor points 70, 71 may be utilized by the graphic generator 1030 to place the pancake 64 at a desired position with respect to the display screen, so that when the users 60, 61 view the pancake 64 in relation to the physical environment, the pancake 64 will be at the correct position with respect to the physical environment. As shown in FIG. 7D, when the pancake 64 is further along its trajectory, the action of the pancake 64 is in close proximity to anchor points 69, 72. In such case, one or both of the anchor points 69, 72 may be utilized by the graphic generator 1030 to place the pancake 64 at a desired position with respect to the display screen, so that when the users 60, 61 view the pancake 64 in relation to the physical environment, the pancake 64 will be at the correct position with respect to the physical environment.

As illustrated in the above example, because the actual positioning of the pancake 64 at various locations along its trajectory is based on different anchor points (e.g., features identified in the physical environment, PCFs, etc.), as the pancake 64 moves across the space, the pancake 64 is accurately placed with respect to the anchor point(s) that is in close proximity to the moving pancake 64 (where the action of the pancake 64 is). This feature is advantageous because it prevents the pancake 64 from being inaccurately placed relative to the environment, which may otherwise occur if the pancake 64 is placed with respect to only one anchor point close to a user. For example, if the positioning of the pancake 64 is based only on the anchor point 70, as the pancake 64 moves further away from the user 61, the distance between the pancake 64 and the anchor point 70 increases. If there is a slight error in the anchor point 70, such as an incorrect positioning and/or orientation of a PCF, then this will result in the pancake 64 being offset or drifting away from its intended position, with the magnitude of the offset or drifting being higher as the pancake 64 is further away from the anchor point 70. The above technique of selecting different anchor points that are in close proximity to the pancake 64 for placing the pancake 64 addresses the offset and drifting issues. The above feature is also advantageous because it allows multiple users who are far (e.g., more than 5 ft, more than 10 ft, more than 15 ft, more than 20 ft, etc.) apart to accurately interact with each other and/or to interact with the same virtual content. In gaming applications, the above technique may allow multiple users to interact with the same object accurately even if the users are relatively far apart. For example, in a gaming application, the virtual object may be virtually passed back-and-forth between users who are far apart. As used in this specification, the term “close proximity” refers to a distance between two items that satisfies a criterion, such as a distance that is less than a certain pre-defined value (e.g., less than: 15 ft, 12 ft, 10 ft, 8 ft, 6 ft, 4 ft, 2 ft, 1 ft, etc.).

It should be noted that the above technique of placing virtual content based on anchor point(s) that is in close proximity to the action of the virtual content is not limited to gaming involving two users. In other embodiments, the above technique of placing virtual content may be applied in any application (which may or may not be any gaming application) involving only a single user, or more than two users. For example, in other embodiments, the above technique of placing virtual content may be utilized in an application that allows a user to place a virtual content that is far away from the user in the physical environment. The above technique of placing virtual content is advantageous because it allows the virtual content to be accurately placed virtually with respect to the user (as viewed by the user through the screen the user is wearing) even if the virtual content is far (e.g., more than 5 ft, more than 10 ft, more than 15 ft, more than 20 ft, etc.) from the user.

As discussed with reference to FIG. 9, the processing unit 1002 includes the non-transitory medium 1040 that is configured to store anchor points information. By means of non-limiting examples, the non-transitory medium 1040 may store positions of the anchor points, different sets of anchor points that are associated with different users, a set of common anchor point(s), selected common anchor point(s) for localization of user and/or for placement of virtual content, etc. The non-transitory medium 1040 may store other information in other embodiments. In some embodiments, the non-transitory medium 1040 may store different virtual contents, which may be retrieved by the graphic generator 1030 for presentation to the user. In some cases, certain virtual contents may be associated with a gaming application. In such cases, when the gaming application is activated, the processing unit 1002 may then access the non-transitory medium 1040 to obtain the corresponding virtual contents for the gaming application. In some embodiments, the non-transitory medium may also store the gaming application, and/or parameters associated with the gaming application.

In addition, as disclosed herein, in some embodiments, the virtual content may be a moving object that moves in the screen based on a trajectory model. The trajectory model may be stored in the non-transitory medium 1040 in some embodiments. In some embodiments, the trajectory model may be a rectilinear line. In such cases, when the trajectory model is applied to a movement of the virtual object, the virtual object will move in a rectilinear path defined by the rectilinear line of the trajectory model. As another example, the trajectory model may be a parabolic equation defining a path that is based on an initial speed Vo and initial movement direction of the virtual object, and also based on a weight of the virtual object. Thus, different virtual objects with different respective assigned weights will move along different parabolic paths.

The non-transitory medium 1040 is not limited to a single storage unit, and may include multiple storage units, either integrated, or separated but communicatively connected (e.g., wirelessly or by conductors).

In some embodiments, as the virtual object moves virtually through the physical environment, the processing unit 1002 keeps track of the position of the virtual object with respect to one or more objects identified in the physical environment. In some cases, if the virtual object comes into contact, or in close proximity, with the physical object, the graphic generator 1030 may generate graphics to indicate an interaction between the virtual object and the physical object in the environment. For example, the graphics may indicate that the virtual object is deflected off from a physical object (e.g., a wall) or from another virtual object by changing a traveling path of the virtual object. As another example, if the virtual object comes into contact with a physical object (e.g., a wall) or with another virtual object, the graphic generator 1030 may place an interaction image in spatial association with the location at which the virtual object contacts the physical object or the other virtual object. The interaction image may indicate that the wall is cracked, is dented, is scratched, is made dirty, etc.

In some embodiments, different interaction images may be stored in the non-transitory medium 1040 and/or may be stored in a server that is in communication with the processing unit 1002. The interaction images may be stored in association with one or more attributes relating to interaction of two objects. For example, an image of a wrinkle may be stored in association with an attribute “blanket”. In such cases, if the virtual object is displayed as being supported on a physical object that has been identified as a “blanket”, then the graphic generator 1030 may display the image of the wrinkle between the virtual object and the physical object as viewed through the screen of the image display device 2, so that the virtual object appears to have made the blanket wrinkled by sitting on top of the blanket.

It should be noted that the virtual content that can be displayed virtually with respect to the physical environment based on one or more anchor points is not limited to the examples described, and that the virtual content may be other items. Also, as used in this specification, the term “virtual content” is not limited to virtualized physical items, and may refer to virtualization of any items, such as virtualized energy (e.g., a laser beam, sound wave, energy wave, heat, etc.). The term “virtual content” may also refer to any content, such as text, symbols, cartoon, animation, etc.

Task Assistant

As shown in FIG. 9, the processing unit 1002 also includes a task assistant 1060. The task assistant 1060 of the processing unit 1002 is configured to receive one or more sensor information, and to assist the user of the image display device in accomplishing an objective involving the virtual content based on the one or more sensor inputs. For example, in some embodiments, the one or more sensor inputs may indicate an eye gaze direction, an upper extremity kinematics, a body position, a body orientation, or any combination of the foregoing, of the user. In some embodiments, the processing unit 1002 is configured to assist the user in accomplishing the objective by applying one or more limits on positional and/or angular velocity of a system component. Alternatively or additionally, the processing unit 1002 may be configured to assist the user in accomplishing the objective by gradually reducing a distance between the virtual content and another element. Using the above pancake tossing game described with reference to FIGS. 5A-5L as an example, the processing unit 1002 may detect that the user is attempting to catch the pancake 64 based on a movement of the controller 4 that has just occurred, based on a current direction and speed of the controller 4, and/or based on a trajectory of the pancake 64. In such cases, the task assistant 1060 may gradually decrease the distance between the pancake 64 and the frying pan 62, such as by deviating from the determined trajectory for the pancake 64 by moving the pancake 64 away from the determined trajectory so that the pancake 64 is closer towards the frying pan 62. Alternatively, the task assistant 1060 may discretely increase a size of the pancake 64 (i.e., computationally and not graphically) and/or increase a size of the frying pan 62 (i.e., computationally and not graphically), to thereby allow the user to catch the pancake 64 easier with the frying pan 62.

In some embodiments, the assisting of the user to accomplish a task involving the virtual content may be performed in response to a satisfaction of a criterion. For example, using the pancake catching game described herein, in some embodiments, the processing unit 1002 may be configured to determine (e.g., predict) if the user will come close (e.g., will be within a distance threshold, such as within 5 inches, 3 inches, 1 inch, etc.) to catching the pancake 64 based on the trajectory of the moving pancake 64, and the movement trajectory of the controller 4. If so, then the task assistant 1060 will control the graphic generator 1030 so that it outputs graphics indicating the pancake 64 being caught by the frying pan 62. On the other hand, if the processing unit 1002 determines (e.g., predicts) that the user will not come close to catching the pancake 64 with the frying pan 62, then the task assistant 1060 will not take any action to help the user accomplish the task.

It should be noted that the task that the task assistant 1060 may help the user accomplish is not limited to the example of catching a flying virtual object. In other embodiments, the task assistant 1060 may help the user to accomplish other tasks if the processing unit 1002 determines (e.g., predicts) that the task will come very close to (e.g., more than 80%, 85%, 90%, 95%, etc.,) being accomplished. For examples, in other embodiments, the task may involve the user launching or sending a virtual object to a destination, such as to another user, through an opening (e.g., a basketball hoop), to an object (e.g., a shooting range target), etc.

In other embodiments, the task assistant 1060 is optional, and the processing unit 1002 does not include the task assistant 1060.

Method Performed by the Processing Unit and/or Application in the Processing Unit

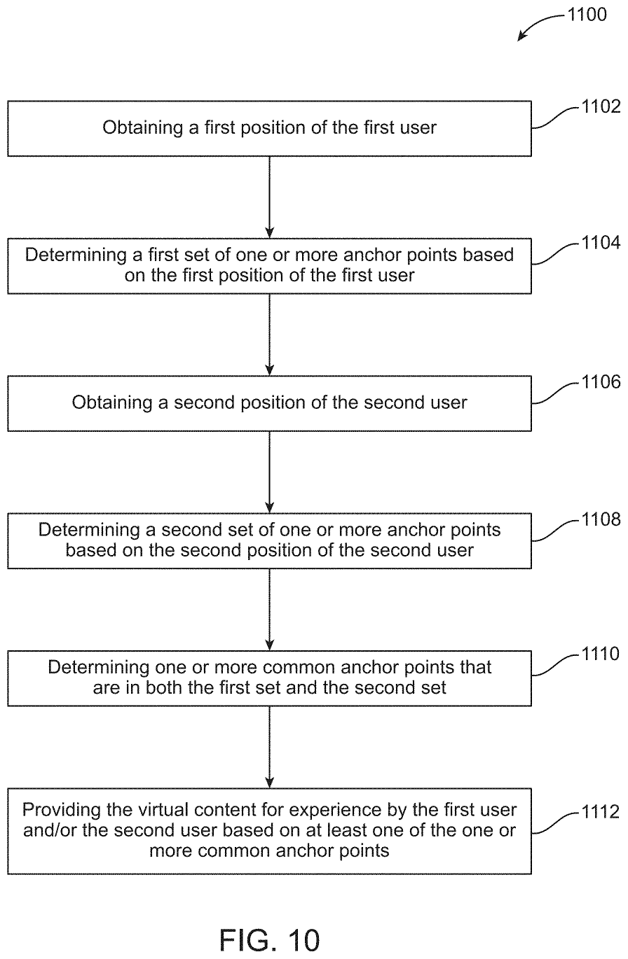

FIG. 10 illustrates a method 1100 in accordance with some embodiments. The method 1100 may be performed by an apparatus configured to provide virtual content in a virtual or augmented environment. Also, in some embodiments, the method 1100 may be performed by an apparatus that is configured to provide a virtual content in a virtual or augmented reality environment in which a first user wearing a first display screen and a second user wearing a second display screen can interact with each other. Each image display device may be the image display device 2 in some embodiments. In some embodiments, the method 1100 may be performed by any of the image display devices described herein, or by multiple image display devices. Also, in some embodiments, at least a part of the method 1100 may be performed by the processing unit 1002, or by multiple processing units (e.g., processing units in respective image display devices). Furthermore, in some embodiments, the method 1100 may be performed by a server or an apparatus that is separate from image display devices being worn by respective users.

As shown in FIG. 10, he method 1100 includes: obtaining a first position of the first user (item 1102); determining a first set of one or more anchor points based on the first position of the first user (item 1104); obtaining a second position of the second user (item 1106); determining a second set of one or more anchor points based on the second position of the second user (item 1108); determining one or more common anchor points that are in both the first set and the second set (item 1110); and providing the virtual content for experience by the first user and/or the second user based on at least one of the one or more common anchor points (item 1112).

Optionally, in the method 1100, the one or more common anchor points comprise multiple common anchor points, and wherein the method further comprises selecting a subset of common anchor points from the multiple common anchor points.

Optionally, in the method 1100, the subset of common anchor points is selected to reduce localization error of the first user and the second user relative to each other.

Optionally, in the method 1100, the one or more common anchor points comprise a single common anchor point.

Optionally, the method 1100 further includes determining a position and/or an orientation for the virtual content based on the at least one of the one or more common anchor points.

Optionally, in the method 1100, each of the one or more anchor points in the first set is a point in a persistent coordinate frame (PCF).

Optionally, in the method 1100, the virtual content is provided for display as a moving virtual object in the first display screen and/or the second display screen.

Optionally, in the method 1100, the virtual object is provided for display in the first display screen, such that the virtual object appears to be moving in a space that is between the first user and the second user.

Optionally, in the method 1100, the one or more common anchor points comprise a first common anchor point and a second common anchor point; wherein the moving virtual object is provided for display in the first display screen, such that the moving virtual object has a first object position with respect to the first display screen, and a second object position with respect to the first display screen; wherein the first object position of the moving virtual object is based on the first common anchor point; and wherein the second object position of the moving virtual object is based on the second common anchor point.

Optionally, the method 1100 further includes selecting the first common anchor point for placing the virtual object at the first object position based on where an action of the virtual object is occurring.

Optionally, in the method 1100, the one or more common anchor points comprise a single common anchor point; wherein the moving virtual object is provided for display in the first display screen, such that the moving virtual object has a first object position with respect to the first display screen, and a second object position with respect to the first display screen; wherein the first object position of the moving virtual object is based on the single common anchor point; and wherein the second object position of the moving virtual object is based on the single common anchor point.

Optionally, in the method 1100, the one or more common anchor points comprise multiple common anchor points, and wherein the method further comprises selecting one of the common anchor points for placing the virtual content in the first display screen.

Optionally, in the method 1100, the act of selecting comprises selecting one of the common anchor points that is the closest to, or that is within a distance threshold from, an action of the virtual content.

Optionally, in the method 1100, a position and/or a movement of the virtual content is controllable by a first handheld device of the first user.

Optionally, in the method 1100, the position and/or the movement of the virtual content is also controllable by a second handheld device of the second user.

Optionally, the method 1100 further includes localizing the first user and the second user to a same mapping information based on the one or more common anchor points.

Optionally, the method 1100 further includes displaying the virtual content by the first display screen, so that the virtual content will appear to be in a spatial relationship with respect to a physical object in a surround environment of the first user.

Optionally, the method 1100 further includes obtaining one or more sensor inputs; and assisting the first user in accomplishing an objective involving the virtual content based on the one or more sensor inputs.

Optionally, in the method 1100, the one or more sensor inputs indicates an eye gaze direction, an upper extremity kinematics, a body position, a body orientation, or any combination of the foregoing, of the first user.

Optionally, in the method 1100, the act of assisting the first user in accomplishing the objective comprises applying one or more limits on positional and/or angular velocity of a system component.

Optionally, in the method 1100, the act of assisting the first user in accomplishing the objective comprises gradually reducing a distance between the virtual content and another element.

Optionally, in the method 1100, the apparatus comprises a first processing part that is in communication with the first display screen, and a second processing part that is in communication with the second display screen.

In some embodiments, the method 1100 may be performed in response to a processing unit executing instructions stored in a non-transitory medium. Accordingly, in some embodiments, a non-transitory medium includes stored instructions, an execution of which by a processing unit will cause a method to be performed. The processing unit may be a part of an apparatus that is configured to provide a virtual content in a virtual or augmented reality environment in which a first user and a second user can interact with each other. The method (caused to be performed by the processing unit executing the instructions) includes: obtaining a first position of the first user; determining a first set of one or more anchor points based on the first position of the first user; obtaining a second position of the second user; determining a second set of one or more anchor points based on the second position of the second user; determining one or more common anchor points that are in both the first set and the second set; and providing the virtual content for experience by the first user and/or the second user based on at least one of the one or more common anchor points.

Specialized Processing System

In some embodiments, the method 1100 described herein may be performed by the system 1 (e.g., the processing unit 1002) executing an application, or by the application. The application may contain a set of instructions. In one implementation, a specialized processing system having a non-transitory medium storing the set of instruction for the application may be provided. The execution of the instruction by the processing unit 1102 of the system 1 will cause the processing unit 1102 and/or the image display device 2 to perform the features described herein. For example, in some embodiments, an execution of the instructions by a processing unit 1102 will cause the method 1100 to be performed.

In some embodiments, the system 1, the image display device 2, or the apparatus 7 may also be considered as a specialized processing system. In particular, the system 1, the image display device 2, or the apparatus 7 is a specialized processing system in that it contains instruction stored in its non-transitory medium for execution by the processing unit 1102 to provide unique tangible effects in a real world. The features provided by the image display device 2 (as a result of the processing unit 1102 executing the instruction) provide improvements in the technological field of augmented reality and virtual reality.

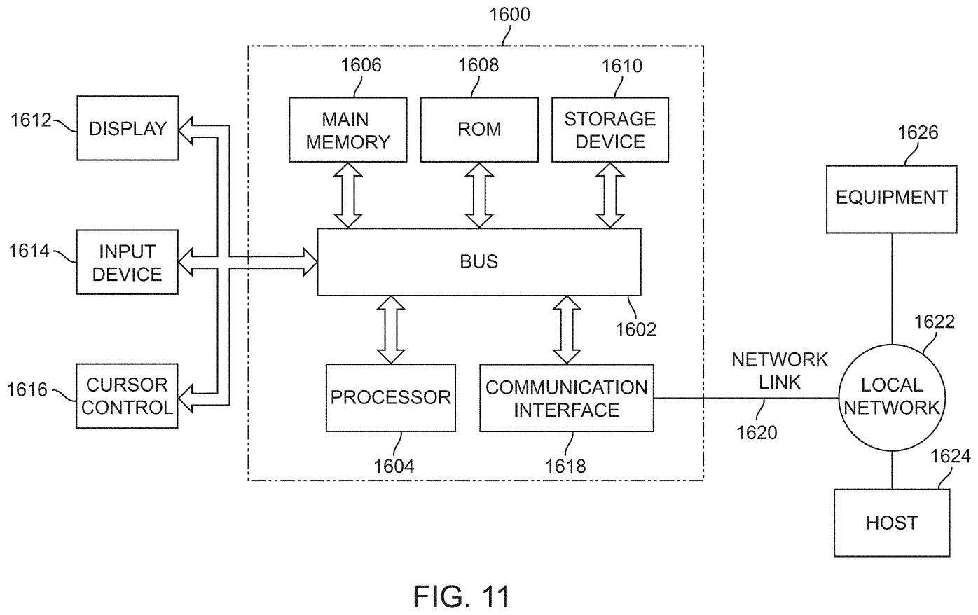

FIG. 11 is a block diagram illustrating an embodiment of a specialized processing system 1600 that can be used to implement various features described herein. For example, in some embodiments, the processing system 1600 may be used to implement at least a part of the system 1, e.g., the image display device 2, the processing unit 1002, etc. Also, in some embodiments, the processing system 1600 may be used to implement the processing unit 1102, or one or more components therein (e.g., the positioner 1020, the graphic generator 1030, etc.).

The processing system 1600 includes a bus 1602 or other communication mechanism for communicating information, and a processor 1604 coupled with the bus 1602 for processing information. The processor system 1600 also includes a main memory 1606, such as a random access memory (RAM) or other dynamic storage device, coupled to the bus 1602 for storing information and instructions to be executed by the processor 1604. The main memory 1606 also may be used for storing temporary variables or other intermediate information during execution of instructions to be executed by the processor 1604. The processor system 1600 further includes a read only memory (ROM) 1608 or other static storage device coupled to the bus 1602 for storing static information and instructions for the processor 1604. A data storage device 1610, such as a magnetic disk, solid state disk, or optical disk, is provided and coupled to the bus 1602 for storing information and instructions.

The processor system 1600 may be coupled via the bus 1602 to a display 1612, such as a screen, for displaying information to a user. In some cases, if the processing system 1600 is part of the apparatus that includes a touch-screen, the display 1612 may be the touch-screen. An input device 1614, including alphanumeric and other keys, is coupled to the bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane. In some cases, if the processing system 1600 is part of the apparatus that includes a touch-screen, the input device 1614 and the curser control may be the touch-screen.

In some embodiments, the processor system 1600 can be used to perform various functions described herein. According to some embodiments, such use is provided by processor system 1600 in response to processor 1604 executing one or more sequences of one or more instructions contained in the main memory 1606. Those skilled in the art will know how to prepare such instructions based on the functions and methods described herein. Such instructions may be read into the main memory 1606 from another processor-readable medium, such as storage device 1610. Execution of the sequences of instructions contained in the main memory 1606 causes the processor 1604 to perform the process steps described herein. One or more processors in a multi-processing arrangement may also be employed to execute the sequences of instructions contained in the main memory 1606. In alternative embodiments, hard-wired circuitry may be used in place of or in combination with software instructions to implement the various embodiments described herein. Thus, embodiments are not limited to any specific combination of hardware circuitry and software.

The term “processor-readable medium” as used herein refers to any medium that participates in providing instructions to the processor 1604 for execution. Such a medium may take many forms, including but not limited to, non-volatile media, volatile media, and transmission media. Non-volatile media includes, for example, optical, solid state or magnetic disks, such as the storage device 1610. A non-volatile medium may be considered an example of non-transitory medium. Volatile media includes dynamic memory, such as the main memory 1606. A volatile medium may be considered an example of non-transitory medium. Transmission media includes coaxial cables, copper wire and fiber optics, including the wires that comprise the bus 1602. Transmission media can also take the form of acoustic or light waves, such as those generated during radio wave and infrared data communications.

Common forms of processor-readable media include, for example, a flexible disk, hard disk, magnetic tape, or any other magnetic medium, a CD-ROM, any other optical medium, any other physical medium with patterns of holes, a RAM, a PROM, and EPROM, a FLASH-EPROM, solid state disks any other memory chip or cartridge, a carrier wave as described hereinafter, or any other medium from which a processor can read.

Various forms of processor-readable media may be involved in carrying one or more sequences of one or more instructions to the processor 1604 for execution. For example, the instructions may initially be carried on a magnetic disk or solid state disk of a remote computer. The remote computer can load the instructions into its dynamic memory and send the instructions over a network, such as the Internet. The processing system 1600 can receive the data on a network line. The bus 1602 carries the data to the main memory 1606, from which the processor 1604 retrieves and executes the instructions. The instructions received by the main memory 1606 may optionally be stored on the storage device 1610 either before or after execution by the processor 1604.

The processing system 1600 also includes a communication interface 1618 coupled to the bus 1602. The communication interface 1618 provides a two-way data communication coupling to a network link 1620 that is connected to a local network 1622. For example, the communication interface 1618 may be a local area network (LAN) card to provide a data communication connection to a compatible LAN. Wireless links may also be implemented. In any such implementation, the communication interface 1618 sends and receives electrical, electromagnetic or optical signals that carry data streams representing various types of information.

The network link 1620 typically provides data communication through one or more networks to other devices. For example, the network link 1620 may provide a connection through local network 1622 to a host computer 1624 or to equipment 1626. The data streams transported over the network link 1620 can comprise electrical, electromagnetic or optical signals. The signals through the various networks and the signals on the network link 1620 and through the communication interface 1618, which carry data to and from the processing system 1600, are exemplary forms of carrier waves transporting the information. The processing system 1600 can send messages and receive data, including program code, through the network(s), the network link 1620, and the communication interface 1618.

It should be noted that the term “image”, as used in this specification, may refer to image that is displayed, and/or image that is not in displayed form (e.g., image that is stored in a medium, or that is being processed).

Also, as used in this specification, the term “action” of the virtual content is not limited to a virtual content that is moving, and may refer to a stationary virtual content that is capable of being moved (e.g., a virtual content that can be, or is being, “dragged” by the user using a pointer), or may refer to any virtual content on which or by which an action may be performed.

Various exemplary embodiments are described herein. Reference is made to these examples in a non-limiting sense. They are provided to illustrate more broadly applicable aspects of the claimed invention. Various changes may be made to the embodiments described and equivalents may be substituted without departing from the true spirit and scope of the claimed invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the claimed inventions. All such modifications are intended to be within the scope of claims associated with this disclosure.

The embodiments described herein include methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

Exemplary aspects of the disclosure, together with details regarding material selection and manufacture have been set forth above. As for other details of the present disclosure, these may be appreciated in connection with the above-referenced patents and publications as well as generally known or appreciated by those with skill in the art. The same may hold true with respect to method-based aspects of the disclosure in terms of additional acts as commonly or logically employed.

In addition, though the disclosure has been described in reference to several examples optionally incorporating various features, the disclosure is not to be limited to that which is described or indicated as contemplated with respect to each variation of the disclosure. Various changes may be made to the disclosure described and equivalents (whether recited herein or not included for the sake of some brevity) may be substituted without departing from the true spirit and scope of the disclosure. In addition, where a range of values is provided, it is understood that every intervening value, between the upper and lower limit of that range and any other stated or intervening value in that stated range, is encompassed within the disclosure.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. It is further noted that any claim may be drafted to exclude any optional element. As such, this statement is intended to serve as antecedent basis for use of such exclusive terminology as “solely,” “only” and the like in connection with the recitation of claim elements, or use of a “negative” limitation.

In addition, as used herein, a phrase referring to “at least one of” a list of items refers to one item or any combination of items. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The breadth of the present disclosure is not to be limited to the examples provided and/or the subject specification, but rather only by the scope of claim language associated with this disclosure.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense.

1. An apparatus for providing a virtual content in an environment in which a first user and a second user can interact with each other, the apparatus comprising:
a communication interface configured to communicate with a first display screen worn by the first user and/or a second display screen worn by the second user; and
a processing unit, the processing unit configured to:
obtain a first position of the first user,
determine a first set of one or more anchor points based on the first position of the first user,
obtain a second position of the second user,
determine a second set of one or more anchor points based on the second position of the second user,
determine one or more common anchor points that are in both the first set and the second set, and
provide the virtual content for experience by the first user and/or the second user based on at least one of the one or more common anchor points.

2. The apparatus of claim 1, wherein the one or more common anchor points comprise multiple common anchor points, and the processing unit is configured to select a subset of common anchor points from the multiple common anchor points.

3. The apparatus of claim 2, wherein the processing unit is configured to select the subset of common anchor points to reduce localization error of the first user and the second user relative to each other.

4. The apparatus of claim 1, wherein the one or more common anchor points comprise a single common anchor point.

5. The apparatus of claim 1, wherein the processing unit is configured to position and/or to orient the virtual content based on the at least one of the one or more common anchor points.

6. The apparatus of claim 1, wherein each of the one or more anchor points in the first set is a point in a persistent coordinate frame (PCF).

7. The apparatus of claim 1, wherein the processing unit is configured to provide the virtual content for display as a moving virtual object in the first display screen and/or the second display screen.

8. The apparatus of claim 7, wherein the processing unit is configured to provide the virtual object for display in the first display screen, such that the virtual object appears to be moving in a space that is between the first user and the second user.

9. The apparatus of claim 7, wherein the one or more common anchor points comprise a first common anchor point and a second common anchor point;
wherein processing unit is configured to provide the moving virtual object for display in the first display screen, such that the moving virtual object has a first object position with respect to the first display screen, and a second object position with respect to the first display screen;
wherein the first object position of the moving virtual object is based on the first common anchor point; and
wherein the second object position of the moving virtual object is based on the second common anchor point.

10. The apparatus of claim 9, wherein the processing unit is configured to select the first common anchor point for placing the virtual object at the first object position based on where an action of the virtual object is occurring.

11. The apparatus of claim 7, wherein the one or more common anchor points comprise a single common anchor point;
wherein processing unit is configured to provide the moving virtual object for display in the first display screen, such that the moving virtual object has a first object position with respect to the first display screen, and a second object position with respect to the first display screen;
wherein the first object position of the moving virtual object is based on the single common anchor point; and
wherein the second object position of the moving virtual object is based on the single common anchor point.

12. The apparatus of claim 1, wherein the one or more common anchor points comprise multiple common anchor points, and wherein the processing unit is configured to select one of the common anchor points for placing the virtual content in the first display screen.

13. The apparatus of claim 12, wherein the processing unit is configured to select the one of the common anchor points for placing the virtual content by selecting the one of the common anchor points that is the closest to, or that is within a distance threshold from, an action of the virtual content.

14. The apparatus of claim 1, wherein a position and/or a movement of the virtual content is controllable by a first handheld device of the first user.

15. The apparatus of claim 14, wherein the position and/or the movement of the virtual content is also controllable by a second handheld device of the second user.

16. The apparatus of claim 1, wherein the processing unit is configured to localize the first user and the second user to a same mapping information based on the one or more common anchor points.

17. The apparatus of claim 1, wherein the processing unit is configured to cause the first display screen to display the virtual content so that the virtual content will appear to be in a spatial relationship with respect to a physical object in a surround environment of the first user.

18. The apparatus of claim 1, wherein the processing unit is configured to obtain one or more sensor inputs; and
wherein the processing unit is configured to assist the first user in accomplishing an objective involving the virtual content based on the one or more sensor inputs.

19. The apparatus of claim 18, wherein the one or more sensor inputs indicates an eye gaze direction, an upper extremity kinematics, a body position, a body orientation, or any combination of the foregoing, of the first user.

20. The apparatus of claim 18, wherein the processing unit is configured to assist the first user in accomplishing the objective by applying one or more limits on positional and/or angular velocity of a system component.

21. The apparatus of claim 18, wherein the processing unit is configured to assist the first user in accomplishing the objective by gradually reducing a distance between the virtual content and another element.

22. The apparatus of claim 1, wherein the processing unit comprises a first processing part that is in communication with the first display screen, and a second processing part that is in communication with the second display screen.

23-45. (canceled)
